(19) United States
(12) Patent Application Publication
(10) Pub. No.: US 2013/0162423 A1
(43) Pub. Date: Jun. 27, 2013

(54) MONITORING AND NOTIFICATION OF CARE RECEIVER ACTIVITY

(71) Applicants: Meredeth Anne Rowe, Gainesville, FL (US); Rande W. Newberry, Homosassa, FL (US); Nevin C. Jenkins, Homosassa, FL (US)

(72) Inventors: Meredeth Anne Rowe, Gainesville, FL (US); Rande W. Newberry, Homosassa, FL (US); Nevin C. Jenkins, Homosassa, FL (US)

(21) Appl. No.: 13/816,302

(22) PCT Filed: Sep. 2, 2011
(86) PCT No.: PCT/US11/50344

§ 371 Date: Feb. 11, 2013

Related U.S. Application Data
(60) Provisional application No. 61/379,510, filed on Sep. 2, 2010.

(51) Int. Cl. G08B 21/02

(52) U.S. Cl. CPC G08B 21/02
USPC 340/501; 340/573.1

(57) ABSTRACT

Various methods and systems related to monitoring the activity of a person receiving assistance from a caregiver are described. In one embodiment, a method for monitoring care receiver (CR) activity includes obtaining an indication that a CR has left a rest location. In response, a sensor of a predefined zone of activity is enabled. A notification is provided in response to activation of the sensor by activity of the CR. In another embodiment, a CR monitoring system includes an occupancy sensor configured to provide an indication that a CR has left a rest location, another sensor configured to monitor CR activity with respect to a zone of activity, and a monitoring device in communication with both sensors. The monitoring device is configured to enable the other sensor in response to an occupancy sensor indication and provide a notification in response to activation of the other sensor by CR activity.

### CROSS REFERENCE TO RELATED APPLICATIONS

This application claims priority to copending U.S. provisional application entitled “Method and apparatus for monitoring activity of persons with cognitive impairment, pervasive developmental disease, or frailty with high fall risk” having Ser. No. 61/379,510, filed Sep. 2, 2010, which is entirely incorporated herein by reference.

### STATEMENT REGARDING FEDERALLY SPONSORED RESEARCH OR DEVELOPMENT

This invention was made with government support under agreements 5R42NR004952-03, 3R42NR004952-03S1, 1R43NR010842-01, and 1R41NR004952-01A1 awarded by the National Institutes of Health (NIH). The Government has certain rights in the invention.

### BACKGROUND

The burden placed on a family member or spouse to deal with cognitively-impaired and frail patients within their home is recognized and it is appreciated that this burden is disruptive to traditional life styles. Someone is selected (e.g., a hired nurse, a spouse, or an adult family member) to serve as an in-home caregiver for a person who is recognized as cognitively impaired or frail and takes on the responsibility to provide the necessary care. One important caregiver function is the monitoring of key parameters indicating the health and welfare of the care receiver and the interpretation of the parameters without formal medical training. For instance, caregivers need to ascertain whether a nighttime activity is safe or unsafe and provide appropriate supervision. The issues with providing care and supervision at night are multiplied for the caregiver and can include sleep disruption, overwhelming worry, and loss of personal space, which can lead to decreased energy levels, changes in mood, and even adverse health effects.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a graphical representation of an example of a protected premise in which the activity of a care receiver is monitored in accordance with various embodiments of the present disclosure.

FIG. 2 is a flow chart illustrating an example of monitoring and notification of CR activity in a protected premise FIG. 1 in accordance with various embodiments of the present disclosure.

FIGS. 3 and 4 are graphical representations of an occupancy sensor included in the monitoring system of FIG. 2 in accordance with various embodiments of the present disclosure.

FIGS. 5-7 are graphical representations of a motion sensor included in the monitoring system of FIG. 2 in accordance with various embodiments of the present disclosure.

FIGS. 8 and 9 are graphical representations of a door sensor included in the monitoring system of FIG. 2 in accordance with various embodiments of the present disclosure.

FIGS. 10-12 are graphical representations of a monitoring device included in the monitoring system of FIG. 2 in accordance with various embodiments of the present disclosure.

FIGS. 13 and 14 are graphical representations of a user interface device included in the monitoring system of FIG. 2 in accordance with various embodiments of the present disclosure.

FIGS. 15-22 are flow charts illustrating set up functions of the monitoring device of the monitoring system of FIG. 2 in accordance with various embodiments of the present disclosure.

FIG. 23 is a schematic block diagram of a monitoring device of the monitoring system of FIG. 2 in accordance with various embodiments of the present disclosure.

### DETAILED DESCRIPTION

Disclosed herein are various methods and systems related to monitoring the physiologic parameters and thresholds of a person receiving assistance from a caregiver (CG). The care receiver (CR) may be a person with a cognitive impairment such as, e.g., dementia or Alzheimer's disease; a pervasive developmental disease such as, e.g., autism or Down's syndrome; or other condition that requires monitoring of the care receiver's physiologic parameters for their well-being. In particular, the activity or other physiologic parameter of a CR who is under the care and supervision of a CG may be monitored and a notification may be provided to the caregiver based upon corresponding notification criteria based upon, e.g., behavior parameters and/or CR profiles. For instance, system monitoring of nighttime activity can distinguish safe and unsafe patterns based upon standard medical knowledge as well as caregiver inputs, and then provide continuous background monitoring of the activity/parameter and provide alerts to the CG when thresholds associated with behavior parameters and/or patterns of activity are exceeded.

With the proper implementation, the monitoring system seamlessly extends the abilities of the caregiver to provide expert care. Additionally, an improved “peace of mind” can be achieved, fear and uncertainty associated with worry can be alleviated, and a better balance of the needs for personal space can be obtained for the caregiver. Also, use of a proper monitoring system at night can make a caregiver's tasks easier and more effective and also provide a CG with the opportunity to obtain an improved quality of sleep. The CR has a reduced risk of nighttime injuries and/or unattended home exits when a CR monitoring (CRM) system is used since the CG can provide supervision for all nighttime awakenings. Reference will now be made in detail to the description of the embodiments as illustrated in the drawings, wherein like reference numbers indicate like parts throughout the several views.

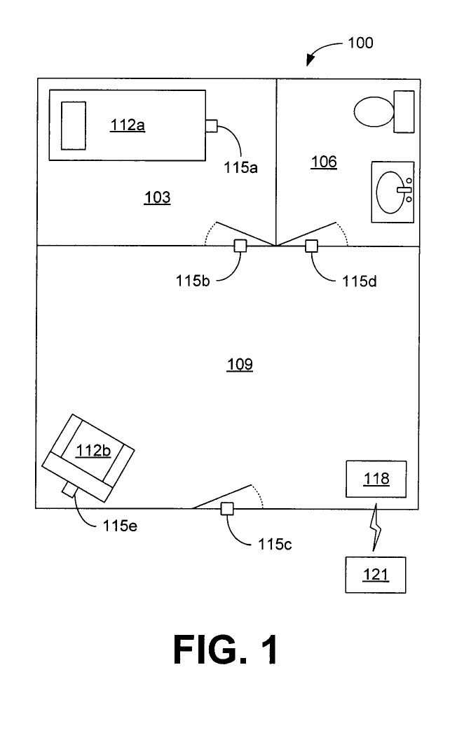

Referring to FIG. 1, shown is a graphical representation of an example of a protected premise 100 such as, e.g., a living space of the CR that may include a bedroom 103, a bathroom 106, a living room 109, etc. For example, the protected premise 100 may be a house, apartment, suite, formal care business, or other defined area. The protected premise 100 includes one or more rest location(s) 112 such as a bed 112a, chair 112b, sofa, or other location where the CR may rest. The protected premise 100 also includes one or more zone(s) of activity that may be defined by the CG or other user of the CRM system. At least one zone of activity includes one or more of the rest location(s).

A CRM system for monitoring CR activity within the protected premise 100 includes a plurality of sensors 115 positioned at various locations about the protected premise 100 to monitor physiologic parameters of the CR such as, e.g., ambulatory activity or other physical conditions of the CR. The sensors 115 may include, but are not limited to, an occupancy sensor 115a for a bed 112a, chair 112b, or other piece of furniture, door sensors, motion detectors, pressure switches, or other sensors that may be used for detecting CR physiologic parameters or detecting conditions of the protected premise 100. The sensors 115 are configured to monitor CR activity within a zone of activity and to detect if a CR passes through an access point along the perimeter of the zone of activity. The sensors 115 may also be configured to monitor other physiologic parameters including, but are not limited to, blood glucose, motor activity during sleep, blood oxygen levels, pulse rate, respiratory rate, arterial tone, and cardiac output.

The CRM system also includes a monitoring device 118 such as, e.g., a master control panel (MCP). The sensors 115 communicate with the monitoring device 118 to provide an indication which is evaluated to determine whether a notification should be provided by the CRM system. Notifications may be provided through an interface of the monitoring device 118 and/or through other user interface devices 121 that are in communication with and may be remotely located from the monitoring device 118. Notifications can include a visual notification, an audio notification, a sensory notification such as a vibration, or a combination of visual, audio, and/or sensory notifications. Notification information can include, e.g., type of notification, notification time, and/or sensor identification. The level of notification is determined based, at least in part, upon predefined behavior parameters (or thresholds) associated with the sensor indications and/or CR profiles. Behavior parameters may include, e.g., whether the CR is out of bed, how long the CR has been out of bed, whether the CR has left the bedroom and/or zone of activity, time out periods associated with sensor activation, etc. The behavior parameters may be tailored by a user such as the CG, to satisfy the needs of the specific CR, the CG, and/or the circumstances of the protected premise 100. CR profiles include patterns of CR activity including behavior parameters and associated notifications. An example of a physiologic parameter would be the level of oxygen in the blood. Using oximetry monitoring, a CG could be alerted to a low CR oxygen level before distress is experienced by the CR.

The time of notification may also cause a change in the level of notification. The CG may take appropriate action based upon the level of notification. For example, a notification message may be displayed when an indication that the CR has moved from a rest location 112 (e.g., bed 112a) is received by the monitoring device 118. If the CR does not return to the rest location 112 within a predefined period of time, an audible alarm may be initiated to alert the CG to the current condition of the CR. While it may not be necessary to actively respond to the initial notification message, the audible alarm can indicate to the CG that a more active response should be taken. In other implementations, an audible alarm may not be issued until additional activity has been detected (e.g., an indication that the CR has left the zone of activity with the rest location 112 such as bedroom 103). Similarly leveled alerts may be based on different values of physiologic parameters.

The various sensors 115 provide indications to the monitoring device 118 such as, e.g., the MCP, which is configured to provide notifications of the CR condition and/or activity, notifications of the CRM system status, and an interface for setup, modification, and/or control of the CRM system functions. The monitoring device 118 may be a base unit located at a specific place or may be a portable unit that may be carried by the CG. While the monitoring device 118 is located within the protected premise 100 in FIG. 1, it may also be located outside the protected premise 100. In addition, other user interface devices 121 in communication with the monitoring device 118 may be used to monitor the CR condition and CRM system status as well as control various CRM system functions when the CG or other user is not near the monitoring device 118. User interface devices 121 include, e.g., a handheld transceiver or other communication device such as a mobile phone, touch pad, or other device such as, e.g., a hand held remote controller (HHRC) that may communicate with the monitoring device 118 though a wireless and/or networked connection.

The CRM system allows a CG who is responsible for taking care of a CR to monitor that person's activity. The CRM system functions non-invasively to the CR, that is, the CR does not need to wear or use any special “locating” device. The CRM system uses various sensors placed about the protected premise 100 to monitor activity within and/or at the perimeters of enclosed areas or defined zones of activity that the CR normally accesses. Each perimeter has at least one sensor 115 (e.g., a door sensor) for monitoring ingress to or egress from the area or zone of activity. For example, in FIG. 1, a first enclosed area or zone of activity may be the bedroom 103 with access monitored by sensor 115b and a second enclosed area or zone of activity may include the bedroom 103, bathroom 106, and living room 109 with access monitored by sensor 115c. In some embodiments, an enclosed area may have multiple ingress/egress points where each access point is monitored by at least one sensor 115. The zones of activity may be defined as nested, overlapping, adjacent, or separate areas.

The CRM system may operate in different modes of operation. The operational mode may be selected by a user of the CRM system and/or may be based upon the activity of the CR, the time of day, and/or the conditions of the protected premise 100. CR profiles associated with the CR can define acceptable and/or unacceptable patterns of each parameter during the operational mode. In some implementations, one or more precondition(s) must be satisfied before the CRM system is allowed to enter the operational mode. For example, all sensors 115 used in the selected mode may need to be in a deactivated or “reset state” (e.g., exit doors closed, bed occupied, etc.). Upon entering the operational mode, some or all of the sensors 115 may be activated or deactivated based upon the operational mode configuration. In some implementations, the group of sensors 115 that are active may change based at least in part upon the CR activity or state. In some implementations, the CRM system may be extended to monitor a plurality of CRs where each CR is associated with at least one CR profile. Notifications may be provided to one or more CR based at least in part upon sensor indications and the CR profiles.

To illustrate the operation of the CRM system, two operational modes will be discussed: a DAY mode and a NIGHT mode. In the DAY mode, a first group of designated or preselected sensors 115 are active. All other sensors 115 are deenergized, disabled, or ignored by the monitoring device 118. For example, the purpose of DAY mode may be to prevent unattended exits from the protected premise 100 by the CR as this can be unsafe and may result in injury or death of the CR. As such, the defined zone of activity during the DAY mode includes the entire protected premise 100 in FIG. 1. For example, sensor 115b may be active to monitor activity along the perimeter of the protected premise 100 (or zone of activity) during the DAY mode, while the remaining sensors 115 are deenergized, disabled, or ignored. In other implementations, the active sensors 115 may also include other sensors 115 located around the perimeter of the protected premise 100 (e.g., window sensors not shown in FIG. 1). In the DAY mode, the CR is free to move within the zone of activity without notifications being sent to the CG. When the CR leaves the zone of activity, sensor 115c sends an indication to the monitoring device 118 and an appropriate level of notification is provided to inform the CG of the activity of the CR. The notification may be provided directly by the monitoring device 118 or may be provided to the CG through a user interface device 121.

In the NIGHT mode, all sensors 115 are active but are only enabled when the bed occupancy sensor 115a indicates that the CR is no longer in bed 112a. In this way, the CG (or other family/household member) is able to move about the protected premise 100 (e.g., to check on the CR) without the CRM system generating a notification because the access sensors 115a, 115b, and 115d remain disabled. In some embodiments, disabled sensors 115 are enabled or disabled in stages associated with zones of activity based at least in part upon sensor indications of the CR activity. For example, if the occupancy sensor 115a indicates that the CR gets out of bed 112a (or other rest location), access sensor 115b is enabled to monitor a first zone of activity and the CRM system alerts the CG to the fact that the CR has moved out of the bed 112a. Sensors 115c, 115d, and 115e remain disabled while the CR remains in the bedroom 103. The CRM system may also include a programmable time out feature (e.g., initially set to 5 minutes) that provides a warning alarm (or other notification) when the CR should have returned to bed (or other rest location), but has not returned within this predefined time limit. If the occupancy sensor 115a indicates that the CR returns to bed 112a, then the time out feature stops and the sensor 115b may be disabled, e.g., after a predefined delay.

If sensor 115b indicates that the CR has left the bedroom 103, then the remaining sensors 115c, 115d, and 115e are enabled to monitor a second zone of activity and a notification of the current condition is provided to the CG by the CRM system. Thereafter, the CRM system can provide further notifications to the CG when the CR triggers any of the enabled sensors 115b, 115c, 115d, and 115e. The level of the notification associated with a sensor 115 may indicate that the CG should take some remedial action to correct the situation. For example, notification messages may be provided if sensor 115d indicates that the CR has entered the bathroom 106 or if sensor 115e indicates that the CR sat down in chair 112b. However, if the CR exits the protected premise 100, the CG is alerted at a higher alarm level based upon an indication from sensor 115c. The sensors 115 that are enabled, as well as the notification levels, may be defined by the CG or other user of the CRM system.

The operational modes may be initiated manually by the CG or other user of the CRM system or may be automatically initiated based at least in part upon a preselected time of day. Satisfaction of other criteria such as, e.g., an indication of occupancy of a rest location 112 may be needed to initiate an operational mode as discussed above. In some implementations, a notification may be provided to prompt a manual change in the operational mode. For example, if an operational mode has not been initiated by a predefined time of day or when a predefined set of conditions are met, a notification message may be sent to prompt the mode change by the CG. While two modes were discussed, other implementations may include additional modes such as, e.g., various day time modes with different levels of monitoring and/or zones of activity. For instance, a daytime away/remote mode may be included for when the CG leaves the protected premise 100. In other implementations, a first daytime mode may provide notifications to the CG and another individual (e.g., a working parent) during a defined time period and a second daytime mode may only provide notifications to the CG when the other individual is at the protected premise 100.

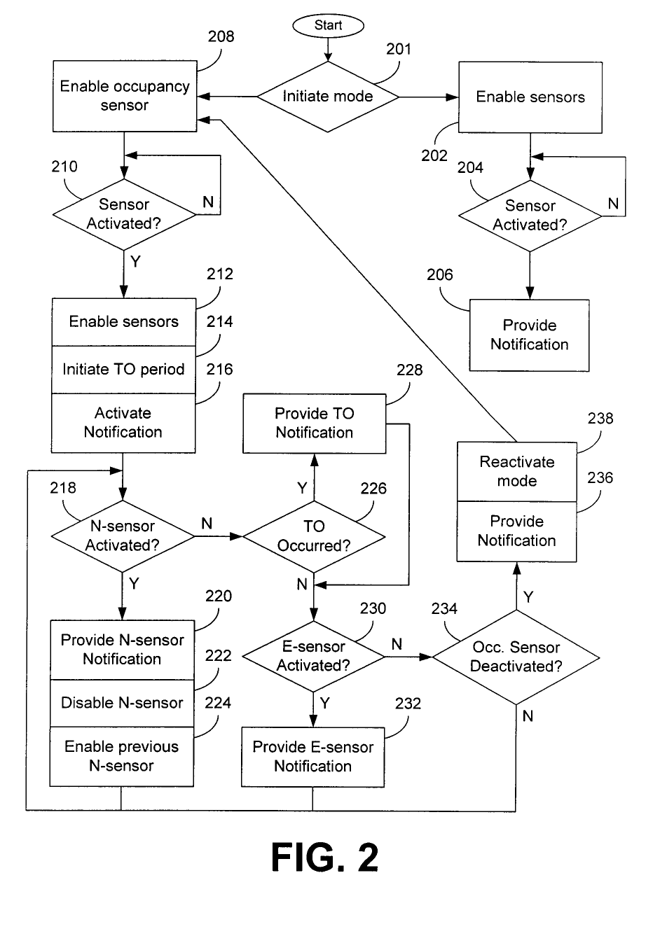

Referring to FIG. 2, shown is a flow chart illustrating an example of monitoring and notification of CR activity in a protected premise 100 of FIG. 1. Beginning with block 201, a CG or other system user may initiate activation of an operational mode. In alternative implementations, the operational mode may be automatically initiated via a timed auto-start function. In the example of FIG. 2, either a NIGHT mode or a DAY mode may be designated. However, in other embodiments, additional modes or other combinations of modes may be defined and available for selection.

If DAY mode is selected, then in block 202 a first group of designated or preselected sensors 115 (FIG. 1) associated with the DAY mode are enabled. The remaining sensors 115 may remain disabled or deactivated during the DAY mode. For example, only the sensor(s) along the perimeter of the protected premise 100 (or zone of activity) such as the door or access sensor 115c may be enabled to allow the CR to move about the protected premise 100 without triggering a notification message or alarm. The preselected group of sensors 115 associated with the DAY mode may be designated emergency sensors or E-sensors. If an emergency condition occurs such as the CR exiting the protected premise 100, the appropriate E-sensor is activated in block 204, resulting in the activation of a notification such as, e.g., an emergency alarm in block 206. The notification type and level may be predefined by the CG and/or other user of the CRM system in a CR profile. For example, a unique audio sequence may be activated at the monitoring device 118 and/or at another user interface device 121 to alert the CG that the CR is leaving the protected premise 100. In some implementations, a combination of notifications such as messages and alarms may be provided in response to the sensor activation in block 204. For example, an audible alarm such as, e.g., a series of beeps and/or a voice message may be provided at the monitoring device 118 (FIG. 1) and a notification message and/or audible alarm may be sent to a portable unit carried by the CG. In some cases, a notification message may be provided by activating a warning light.

On the other hand, if the NIGHT mode is initiated in block 201, then in block 208 an occupancy sensor 115 (FIG. 1) corresponding to a rest location (e.g., a bed occupancy (BO) sensor 115a, chair occupancy sensor 115e, or other appropriate sensor 115) is enabled. When the rest location is occupied (e.g., when the CR is in bed 112a), then the occupancy sensor 115 remains deactivated. If the CR leaves the rest location 112, then the occupancy sensor 115 is activated in block 210. In some implementations, the monitoring device 118 queries the occupancy sensor 115 to determine its condition or status. If the occupancy sensor 115 has not activated, the CRM system loops back to block 210 after a predefined delay to recheck the occupancy sensor 115 condition. In other implementations, the occupancy sensor 115 is configured to automatically provide an indication to the monitoring device 118 in response to activation.

If the occupancy sensor 115 is activated in block 210, then some or all of the sensors 115 in the protected premise 100 are enabled in block 212, an occupancy timeout (TO) period starts in block 214, and/or an occupancy notification goes active in block 216 when the CR leaves the bed. The enabled sensors 115 include the first group of E-sensors activated in block 204 and a second group of notification sensors 115 or N-sensors associated with the NIGHT mode. Different levels of notification may be associated with the different groups of sensors 115. The level of notification (e.g., a message, indicating/warning light, audible alarm, voice message, or combinations thereof) may be defined by the CG or other user of the CRM system. In the example of FIG. 1, the E-sensor group includes access sensor 115c and the N-sensor group includes access sensors 115b and 115d. Sensor 115b may monitor a first zone of activity (e.g., bedroom 103) and sensors 115b, 115c, and 115d may monitor a second zone of activity including the first zone. The occupancy sensor 115e may also be included in the N-sensor group. While the example of FIG. 2 provides for two groups of sensors, additional groups of sensors may be included as can be understood.

Activation of the occupancy notification 216 may also immediately send a notification to provide the CG with notice of the status of the CR. The level of notification is based upon the level defined by the CG or other user of the CRM system in the CR profile. For example, activation of E-sensors may result in audible alarms and activation of N-sensors may result in notification messages and/or warning lights. In some implementations, notifications may be defined for individual sensors 115.

Responsive to the activation of the occupancy notification 216, the CRM system determines if an N-sensor has activated in block 218. If an N-sensor has been activated, then the N-sensor notification goes active to provide a notification to the CG in block 220, the N-sensor may be disabled in block 222, and the previous N-sensor (if there was one) may be enabled in block 224 before the flow returns to block 218. This prevents multiple notifications from being generated by repeated activation of the sensor 115 by continued CR activity. If not, the CRM system determines if the occupancy timeout has occurred in block 226. If the timeout period has expired, then a timeout notification such as, e.g., the activation of a timeout warning alarm is provided in block 228. The flow may then proceed forward to block 230 to determine if an E-sensor has activated.

If a timeout has not occurred in block 226, the CRM system determines if an E-sensor has activated in block 230. If an E-sensor has been activated, then the E-sensor notification goes active to provide a notification to the CG in block 232. In some implementations, the notification of block 232 may be the same notification provided in block 206. The flow may then return to block 218 to continue monitoring the enabled sensors 115. If an E-sensor has not been activated, then in block 234 the CRM system determines if the occupancy sensor (e.g., BO sensor 115a) has returned to a deactivated state indicating that the CR has returned to the rest location (e.g., bed 112a). If not, then the flow returns to block 218 to continue monitoring the enabled sensors 115. If the occupancy sensor (e.g., BO sensor 115a) has returned to normal, then a notification such as, e.g., a notification message and/or special audio signal is provided in block 236 to notify the CG of the return of the CR. In some implementations, the NIGHT mode is reactivated (e.g., by the CG) in block 238 and the occupancy sensor is again enabled in block 208. In other embodiments, the NIGHT mode may remain activated with the occupancy sensor enabled if a timeout has not occurred. The CRM system then resumes monitoring in block 210.

The CRM system alerts the CG when the CR is not where he/she should be like e.g., at night when the CR should be in bed 112a (FIG. 1) based at least in part upon the CR profile. Initially, the CRM system alerts the CG if the CR has moved out of the rest location (e.g., bed 112a). The CRM system may also provide feedback to the CR upon an indication of leaving the rest location 112. For example, the CRM system may play a voice message (e.g., a message recorded by the CG) through a speaker in the bedroom 103 (FIG. 1) that prompts the CR to return to bed. A light may also be activated to aid in orientation of the CR within the bedroom 103. Thereafter, the CRM system may alert the CG when the CR activates any of the enabled sensors 115 (FIG. 1) informing the CG of the CR's activity and which sensor 115 was activated or tripped via a MCP and/or other user interface device 121 such as, e.g., a hand held remote controller (HHRC). As discussed above, the CRM system may include a programmable time out feature that provides a warning alarm when the CR has not returned to bed 112a within a time limit defined by the CG or other user. In some implementations, the CRM system may immediately announce an emergency condition (e.g., an audible alarm via the MCP and/or the HHRC) to which the GC must respond when one or more designated sensors 115 (e.g., the E-sensor group) are activated based upon the CR profile.

The CRM system may also account for predefined activity patterns of the CR included in a CR profile. For example, the CR may have a consistent pattern of waking up at 2:00 a.m. to go to the bathroom. In this case, the CG may setup the CRM system to provide a different set of notifications based upon a defined pattern in the CR profile. For instance, the CG may specify that only a notification message be provided if door sensors 115b and 115d are activated when the CR is out of bed between 1:45 a.m. and 2:15 a.m. as this me be considered to be a known and acceptable activity for the CR. Activation of the door sensors 115b and 115d by CR activity outside of the defined time period would result in a higher level of notification such as, e.g., an audible alarm.

Predefined activity patterns may also be used to provide an early warning of a prohibited (or potentially dangerous) CR activity. For example, if a pattern of CR activity has been identified that consistently leads up to the CR leaving the protected premise 100, then the CRM system may be setup to provide a warning notification if the CR activities leading up to the prohibited activity are detected. For example, if it has been determined that when the CR gets out of bed 112a and leaves the bedroom 103 within two minutes of getting out of bed 112a that the CR will likely be heading for the exit of the protected premise 100, then the CR profile may be setup for the CRM system to provide an alarm notification to warn the CG if the door sensor 115b is activated within two minutes of the BO sensor 115a being activated. In addition, the CR profile may define various levels of notification based upon the elapsed time between the two activations (or sensor indications), which provide a suggestion of the speed of the CR movement and may indicate that the CG has less time to respond. The level of notification may also be adjusted based the condition of the protected premise 100. For example, if the door exiting the protected premise 100 is locked, then the notification level may be lowered because of the added protection and/or delay.

The CRM system may track and record the CR activity patterns and provide notifications to the CG of changes in previously defined activity patterns or the development of new activity patterns of the CR. In some implementations, the CRM system may learn the CR activity patterns and provide a notification when the CR deviates from the normal pattern. For example, the CRM system may learn that the CR gets out of bed between 8:50 a.m. and 9:10 a.m. every day. If the CR does not get out of bed within a predefined threshold (e.g., 15 minutes) of this time range, then the CRM system would provide a notification (e.g., a warning light and notification message describing the deviation) to indicated that the CR is acting abnormally. The CRM system may also identify patterns in the CG initiation or change of the operational mode (e.g., for each day of the week) and may automatically provide notifications to remind the CG.

Based on the typical nighttime patterns of the CR, the system may provide verbal and/or light cueing at the site of an active sensor 115 to provide feedback for appropriate actions by the CR. For example, a CR can be verbally cued to use the bathroom upon awakening (as may be indicated, e.g., by CR motor activity when in bed) or leaving bed, and then to return to bed after using the bathroom. Alternatively, the correct path can be lighted based on sensor activation or firing. For instance, with reference to FIG. 1, when the BO sensor 115a is activated, the path to the bathroom 106 could be lighted by automatically turning on a light in the bathroom 106 or by turning on a light on door sensor 115b and/or 115d. As the CR leaves the bathroom 106, the lights would be extinguished as the CR passes sensors 115d and/or 115b while returning to bed 112a. This is a benefit to the CG since it allows the CG to remain in bed while the CR safely performs a routine activity during the night. This cueing may be based on predefined activity patterns of the CR profile or based on machine learning principles using software implemented by the monitoring device 118 or other computing device. For example, another computing device may access the monitoring device 118 through a network connection to access and evaluated recorded CR activity data. Machine learning can also be used to preempt alerts to the CG when the system has been so programmed by the CG. In this mode, normal and safe activity of the CR is allowed without alerts to the CG, but any other activity produces alert notifications as indicated by the CR profile.

The CRM system may also allow the recorded CR activity patterns be accessed for later evaluation by the CG, a healthcare professional, or other authorized user. In some embodiments, the CRM system may provide recommendations for changing the defined activity patterns or adding a new activity pattern in the CR profile based upon the recorded CR activity patterns. The recommendations may be based upon a database of known patterns, expert system rules, and/or other pattern recognition techniques.

The CRM system may also track and record the CG response activity. Notifications provided by the CRM system of CR activity may require that the CG take certain actions and/or provide feedback to the CRM system, which may be tracked and recorded for later access and evaluation. For example, if an audible alarm is provided, the CG or other user may be required to acknowledge the alarm through an interface of the monitoring device 118 (FIG. 1) and/or through other user interface devices 121. The acknowledgement, as well as other sensor indications, may be recorded and used to analyze the CG time to respond to the notification. If the CG does not provide the required action, then a notification at a higher level may be provided such as, e.g., a louder or more strident audible alarm. In some implementations, the notification and information regarding the CG response may be provided by the CRM system to another user (e.g., a working spouse of the CG or CR) who may not be present at the protected premise 100 (FIG. 1).

As illustrated in FIG. 1, the CRM system also includes a monitoring device 118 such as, e.g., a master control panel (MCP), in communication with a plurality of sensors 115 located about the protected premise 100 such as, but not limited to, occupancy sensors, motion sensors, door sensors, or other sensors as can be appreciated. In some embodiments, the CRM system may also utilize sensors 115 located outside the protected premise 100 such as, e.g., motion sensors, door sensors, etc. to provide additional indications of CR activity. Communications may be through a wired or wireless connection such as, e.g., a bluetooth link, infrared link, Wi-Fi link, or other radio frequency (RF) link. The RF link for communications between sensors 115 and the monitoring device 118 may be characterized by a RF frequency band such as, e.g., a 2.4 Ghz (ISM band), component zones (e.g., the # of sensors), and use of a data protocol such as Zigbee. During setup of the CRM system, each sensor 115 is named or identified with, e.g., the location that it is monitoring. This name or location is utilized by the CRM system to identify the sensor 115 in a notification when it has been activated.

Occupancy sensors include pressure, infrared, motion, or other sensors that may be used to detect the presence of the CR in a rest location such as a bed, chair, sofa, etc. For example, a bed occupancy (BO) sensor 112a (FIG. 1) may include an air mattress placed under the CR's bed that has an air pressure sensor that can sense or detect if the CR is in the bed or has moved out of the bed. The pressure sensor may transmit the sensor status to the monitoring device 118 through a wired or wireless connection using, e.g., an RF transceiver.

An occupancy sensor may include an air bag or bladder, for placement between a box springs and the mattress in the user's bed or between a cushion and frame of a chair or sofa, which is connected by a hose to a pressure switch, which is, in turn, connected to a transmitter. The air bag may be, e.g., a slightly modified camping air mattress (e.g., about 26″ wide by about 75″ long by about 1.5″ thick) that is filled with a very light foam. The valve can be removed from the air mattress nozzle and a short plastic tube may be attached (e.g., glued) over it and led to an air pressure switch, which is open when pressure in the mattress is low and closed when the pressure is high. The air pressure switch is connected to a transmitter or transceiver (e.g., a Honeywell Security Systems transmitter) that sends a signal to a remote receiver when the pressure switch terminals open or close.

When used in a bed, the occupancy sensor 115a (FIG. 1) may be positioned between the box spring and the bed mattress, with the hose free and not connected to the pressure switch. The weight of the bed mattress compresses the foam within the air mattress, driving some, but not all, of the air out of the mattress. The hose is then connected to the pressure switch. The pressure switch with the transmitter is also placed between the bed mattress and the box spring. The pressure switch remains open without additional pressure being applied to the bed. The occupancy sensor may be similarly used in a chair, sofa, or other furniture as can be appreciated.

When a CR sits or lays anywhere on the bed 112a (FIG. 1), his or her weight compresses the air mattress, increasing the air pressure within it and causing the pressure switch to close. The transmitter or transceiver sends a signal indicating that the occupancy sensor 115a is deactivated, reporting the increased air pressure to the monitoring device 118 (FIG. 1), and, in effect, the presence of the CR on the bed 112a. When the CR gets off the bed, the air pressure within the mattress drops, the switch terminals open again, and the same transmitter or transceiver sends an activation signal, in effect indicating that the CR has left the bed. With the CR's weight is distributed over a large area of the air mattress, it matters very little whether the CR lies or sits on the bed as the air pressure within the mattress increases enough to close the pressure switch.

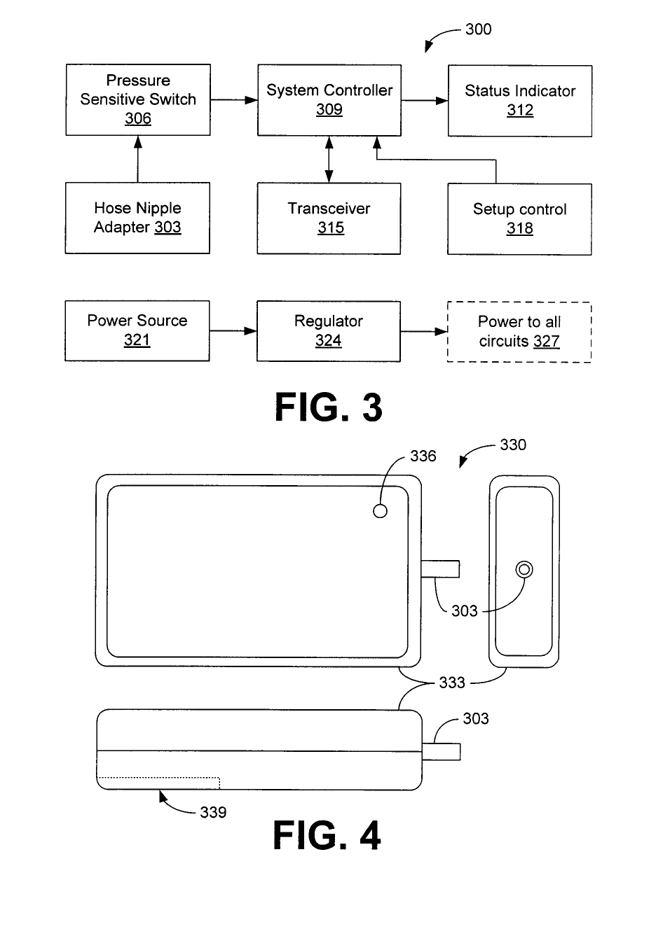

Referring to FIG. 3, shown is a block diagram 300 of an example of an occupancy sensor (e.g., 115a or 115e of FIG. 1) in accordance with various embodiments of the present disclosure. A hose nipple adapter 303 is connected to the hose of an air bag or bladder (e.g., an air mattress) and is connected to a pressure sensitive switch 306 that translates pressure to an electrical signal that is fed to a system micro-controller 309. The system micro-controller 309 outputs a signal to the status indicator 312 that provides a visual notification (e.g., a flashing LED) when the pressure sensor changes state. The system micro-controller 309 also outputs a signal to, e.g., a RF transceiver module 315 that is sent to the monitoring device (e.g., the MCP) 118 (FIG. 1). The RF transceiver 315 may utilize a data protocol such as Zigbee or other appropriate data protocol for transmission of the occupancy sensor status. A setup control 318 such as, e.g., PRM dip switches may be connected to the system micro-controller 309. Power may be provided by a power source 321 connected to a power regulator 324 that in turn, connects to power all circuits 327 in the occupancy sensor.

FIG. 4 illustrates an example of the packaging of the electronic components of an occupancy sensor 330. The components of FIG. 3 are housed in a housing or case 333 with the hose nipple 303 and an LED 336 of the status indicator 312 of FIG. 3. The occupancy sensor 300 sends an alert to the monitoring device 118 (FIG. 1) when changes in the state of the pressure switch 306 (FIG. 3) are detected. The Pressure switch 306 may be adjustable using the setup control for CR weights down to about 30 lbs. and may be factory set for a CR weight of about 50 lbs. to activate for most typical applications. The hose adapter 303 may be sized to fit existing bed mattress hose sizes. The indicator LED 336 may be a red LED that blinks (about ¼ second on) when the pressure sensor changes state. This is useful in testing the setup of the occupancy sensor 330. A battery compartment 339 may be provided in housing 333 for the power source 321 of FIG. 3. Battery power using, e.g., three AAA size alkaline batteries provides an estimated battery life of about two years. The occupancy sensor 330 may communicate with the monitoring device 118 on a regularly scheduled basis (e.g., once every 5 minutes) to report the battery condition and the ambient temperature of the occupancy sensor 330.

Motion detectors include passive infrared (PIR) sensors and other types of motion sensors that communicate with the monitoring device 118 through a wired or wireless connection such as, e.g., a bluetooth link, infrared link, Wi-Fi link, or other RF link. PIR sensors may include a slotted IR window to “narrow” the field of view to act as a curtain on a doorway to determine if the CR has passed through the doorway. The PIR sensors may be positioned to direct the IR curtain at, e.g., a doorway (or window) so that only motion close to or passing through the doorway and at a preset level above the floor will activate the sensor. This allows pets to pass through the doorway without triggering the sensor. The motion detector may be battery powered or include a battery backup.

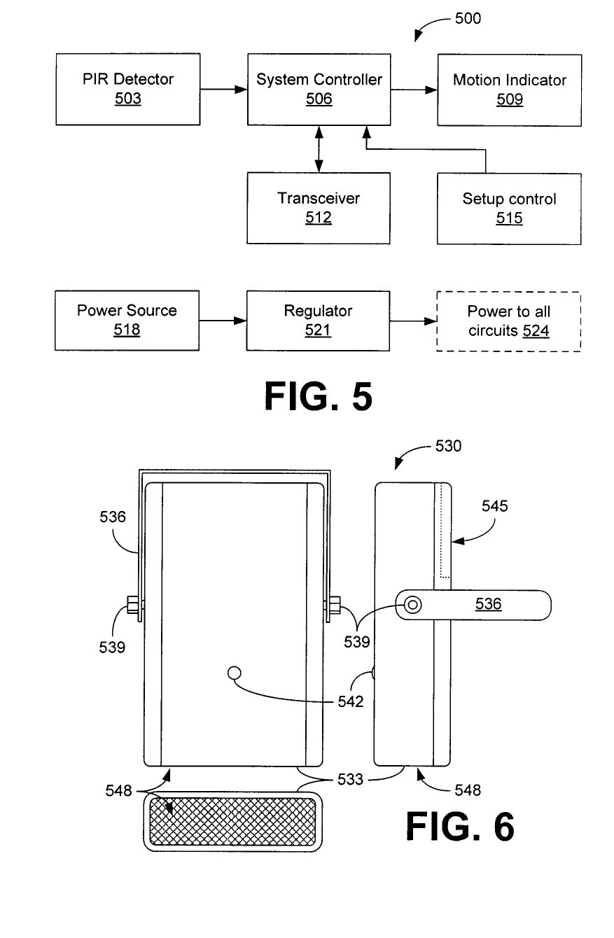

Referring to FIG. 5, shown is a block diagram 500 of an example of a PIR motion sensor (e.g., 115b, 115c, or 115d of FIG. 1) in accordance with various embodiments of the present disclosure. A PIR detector 503 with support circuitry is connected to a system micro-controller 506 that sends a signal to a motion indicator 509 that provides a visual notification (e.g., a flashing LED) when motion is detected. The system micro-controller 509 also outputs a signal to, e.g., a RF transceiver module 512 that is sent to the monitoring device (e.g., the MCP) when activated by motion. The RF transceiver 512 may utilize a data protocol such as Zigbee or other appropriate data protocol for transmission of the occupancy sensor status. A setup control 515 such as, e.g., PRM dip switches may be connected to the system micro-controller 506. Power may be provided by a power source 518 connected to a power regulator 521 that in turn, connects to power all circuits 524 in the PIR sensor.

FIG. 6 illustrates an example of the packaging of the components of a PIR motion sensor 530. The components of FIG. 5 are housed in a housing or case 533 with a mounting bracket 536 attached to the case 533 using thumb screws 539 for securing the mounting bracket 536 at proper angles. An LED 542 of the motion indicator 509 of FIG. 5 is mounted in the cover of the case 533. The indicator LED 542 may be a red LED that blinks (about ¼ second on) when motion is detected. This is useful in testing the setup of the PIR motion sensor 530. A battery compartment 545 may be provided in case 533 and an IR lens 548 is provided at one end of the case 533 for power source 518 of FIG. 5. Battery power using, e.g., three AAA batteries size alkaline batteries provides an estimated battery life of about two years. The PIR motion sensor 530 may communicate with the monitoring device 118 on a regularly scheduled basis (e.g., once every 5 minutes) to report the battery condition and the ambient temperature of the PIR motion sensor 530.

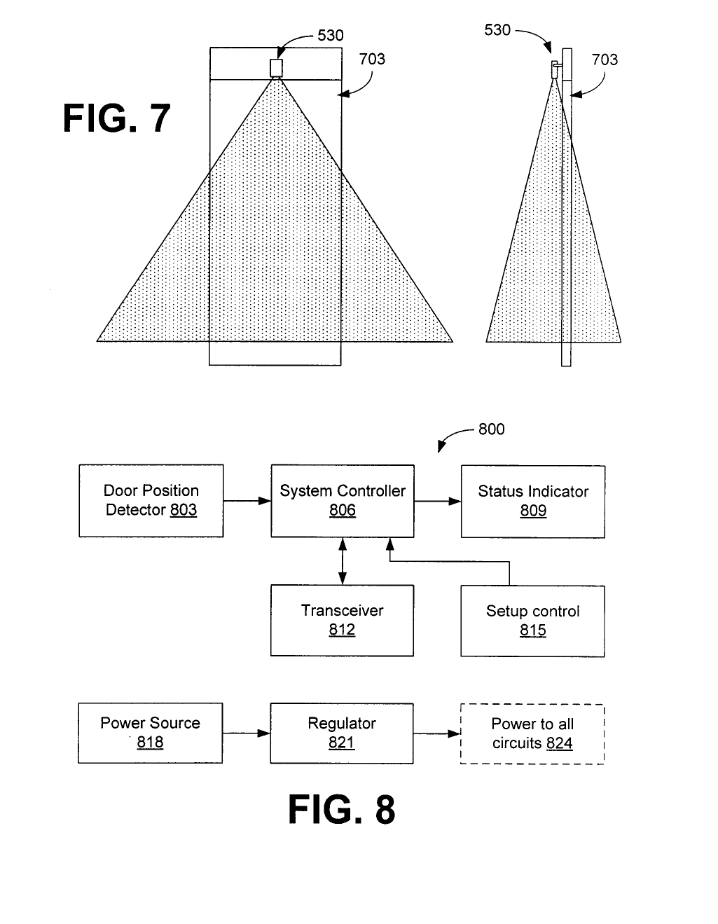

Referring next to FIG. 7, shown is an example of the coverage area of the PIR motion sensor 530 mounted over a doorway 703 by a secure mounting bracket 536 (FIG. 6). The PIR motion sensor 530 is mounted at the top of a doorway 703 and senses motion in an approximate field of view in a direction perpendicular to the face of the IR lens 548 (FIG. 6) as illustrated in FIG. 7. As shown, the coverage in the plane of the doorway 703 will be almost complete while the coverage in a direction normal to the plane of the doorway will be substantially confined to avoid false indications. In addition, the range of the IR beam may be adjusted to above the height of pets in the protected premise to prevent pet movement from activating the PIR motion sensor 530.

Door sensors include capacitive, inductive, or magnetic sensors that indicate the position (open/closed) of the door (or window). These sensors are battery powered and accept a hard wired contact input from a capacitive or magnetic door/window alarm contact set, and send the status of the door (or window) to the monitoring device 118 through, e.g., a wired or wireless connection such as, e.g., a bluetooth link, infrared link, Wi-Fi link, or other RF link when the contacts are broken, e.g., when the door (or window) is opened.

Referring to FIG. 8, shown is a block diagram 800 of an example of a door sensor (e.g., 115b, 115c, or 115d of FIG. 1) in accordance with various embodiments of the present disclosure. A door position detector 803 such as, e.g., a normally closed (NC) security type magnetic switch is connected to a system micro-controller 806. The system micro-controller 806 outputs a signal to the status indicator 809 that provides a visual notification (e.g., a flashing LED) when the door sensor changes state. The system micro-controller 806 also outputs a signal to, e.g., a RF transceiver module 812 that is sent to the monitoring device (e.g., the MCP) 118 (FIG. 1). The RF transceiver 812 may utilize a data protocol such as Zigbee or other appropriate data protocol for transmission of the door sensor status. A setup control 815 such as, e.g., PRM dip switches may be connected to the system micro-controller 806. Power may be provided by a power source 818 connected to a power regulator 821 that in turn, connects to power all circuits 824 in the door sensor.

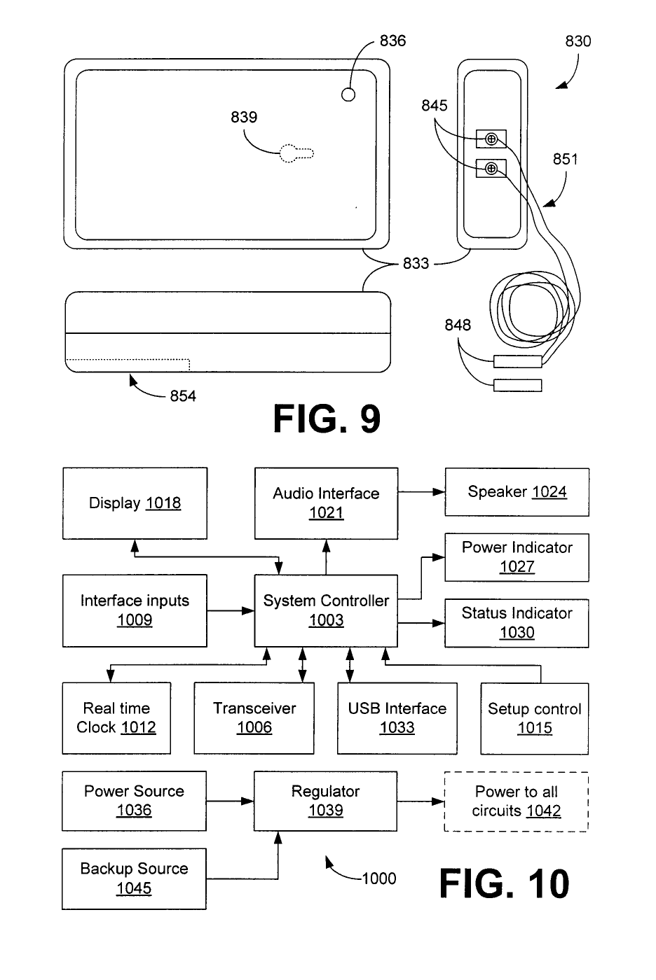

FIG. 9 illustrates an example of the packaging of the electronic components of a door sensor 830. The components of FIG. 8 are housed in a housing or case 833 with an LED 836 of the status indicator 809 of FIG. 8. A screw key hole 839 may also be milled in the back of the case 833 for ease of mounting. A pair of pass-through contacts 845 with screw terminals are mounted in an end face of the case 833 to enable the door position detector 803 (FIG. 8), e.g., a magnetic contact switch 848 or other appropriate door detector assembly, to be connect to the electronic components of FIG. 8 inside the case 833 via wires 851. The magnetic switch 848 may be located with the switch element with wires 851 mounted on the door jamb and the magnet element on the door so that the magnet pulls the switch contacts closed when the door is closed and the contacts open when the door is opened.

The door sensor 830 sends an alert to the monitoring device 118 (FIG. 1) when a change in the state of the magnetic switch 848 is detected. The magnetic switch 848 of the door position detector 803 (FIG. 8) may be a standard commercially available normally closed switch set used for security system applications. In other embodiments, the door sensor 830 may be used with a variety of commercially available security contacts for use with window protection, glass breakage, motion detectors, etc. The indicator LED 836 may be a red LED that blinks (about ¼ second on) when the magnetic switch 848 opens. This is useful in testing the setup of the door sensor 830. A battery compartment 854 may be provided in housing 833 for power source 818 of FIG. 8. Battery power may be provided using a preselected number of batteries (e.g., three AA size alkaline batteries) that provide an estimated battery life of, e.g., about two years. The door sensor 830 may communicate with the monitoring device 118 on a regularly scheduled basis (e.g., once every 5 minutes) to report the battery condition and the ambient temperature of the door sensor 830.

The various sensors 115 (FIG. 1) are monitored by the monitoring device 118 (FIG. 1) that gives the CG audible and/or visual notifications of the CRM system status as well as voice messages, and also provides various programming functions for setting the CRM system components relative to a specific installation. The sensors 115 may be designated as one (or more) of multiple sensor classifications using a setup option at the monitoring device 118. For example, as discussed above the sensors 115 may be designated as an emergency sensor (E-sensor), a notification sensors (N-sensor), or other classification as may be defined by a user of the CRM system. Notifications such as status indicators may then be provided by the CRM system based at least in part upon the sensor classification and the operational mode of the CRM system. For example, different status indicators may be provided based upon four operational conditions: a normal status, a notification status, a warning status, and an emergency status. During setup of the CRM system, each sensor 115 is named or identified with, e.g., the location that it is monitoring to identify the sensor 115 in a notification when it has been activated.

When operating in a normal status, sensors 115 can be set in a notification or emergency status for either day mode or night mode. The monitoring device 118 displays the status of the CRM system, and there is no audible notification associated with this status except, e.g., a voice message announcing “day mode activated” or “night mode activated” when the mode is selected at the monitoring device 118.

A notification status may be invoked during, e.g., the night mode when a bed occupancy (BO) sensor 115a (FIG. 1) is enabled. The BO sensor 115a is activated when the CR leaves the bed 112a (FIG. 1). An example of the notifications that may be provided by the monitoring device 118 for the CG when the BO sensor 115a is activated includes:
A display that shows that the BO sensor 115a was activated.
An audio notification that beeps 3 times followed by a voice message announcing that the BO sensor 115a was activated, then pauses for 3 seconds, then repeats this audio notification again. After repeating the announcement at least 2 times, the audio notification may stop.
A display that indicates an ALERT status and that the BO sensor 115a remains activated.
If the BO sensor 115a remains activated for a predefined time out period, the another audio notification may be provided that beeps 5 times followed by a voice message announcing “warning still out of bed.” The audio notification may then pause about 5 seconds before repeating once again. The sequence may be repeated every 2 minutes for at least 3 cycles and then escalates to an emergency alarm with the voice continuously announcing “emergency still out of bed” until the CG manually stops the alarm.

The intensity of the audio notification may be selected to be either low or high from the monitoring device 118. A corresponding notification may also be provided on a remote handheld transceiver or other user interface device 121 through, e.g., a highly visible flashing light and a series of audible beeps. The beeps may only occur once but the flashing light may continue to provide a verification of the notification. The level of notification and notification sequence may be defined in the CR profile. When the CR returns to bed (rest location 112a of FIG. 1) before the occupancy timeout (TO) expires, the notification status stops and the CRM system reverts to the normal status. If the occupancy TO countdown is completed without the CR returning to bed, the status of the CRM system changes to a warning status.

A warning status may occur in, e.g., the night mode when the occupancy TO period has run out (counted down to zero), a warning notification is provided by the monitoring device 118. An example of the notifications that may be provided by the monitoring device 118 include:
A display that shows WARNING and the last sensor that was activated.
An audio notification that beeps 5 times followed by a voice message played through the speaker announcing “warning still out of bed.” The audio notification may then pause about 5 seconds and may be repeated every 2 minutes for at least 3 cycles.
The notification level will then escalate to an emergency alarm with a voice message continuously announcing “emergency still out of bed” until the CG manually stops the audible alarm.

The intensity of the audio notification may be selected to be either low or high from the monitoring device 118. A corresponding notification may also be provided on a remote handheld transceiver or other user interface device 121 through, e.g., a highly visible flashing light and a series of audible beeps. The beeps occur once, pause a few seconds, then repeat as the flashing light continues to provide a verification of the notification. The level of notification and notification sequence may be defined in the CR profile.

A warning notification may not stop until the CG has manually preformed one of the following actions to deactivate the notification:
Placing the CRM system in standby (or alarm silence) by, e.g., pressing a key or button on the monitoring device 118 or a remote user interface device.
Shutting down the CRM system.
   If the CR returns to the rest location (bed) while the CRM system is in standby, then the system will revert to a normal operating night mode.

An emergency status may occur when an E-sensor is activated or tripped or if an occupancy warning timeout has expired. An example of the emergency notifications that may be provided by the monitoring device 118 include:
A display shows EMERGENCY and the last sensor that was activated.
An audio notification that rapidly beeps and a voice message is played through the speaker announcing “emergency condition [and the sensor name that caused the alarm].” The alarm notification is repeated until the CG manually stops the alarm.

The intensity of the audio notification may initially start at the same intensity as a warning alarm setting, and can escalate in stages, e.g., after each 5 successive announcements to the maximum system volume, which may be selected to be either low or high from the monitoring device 118. The low audio setting for the emergency notification may be at a slightly higher intensity than the high audio setting of a warning notification. In other implementations, this can be an escalating sound with first several announcements at the same sound level that is set for the notification alarm. The sound level can be initially set at a normal level by the CG and only escalates when there is no response after a preselected time period. An emergency notification may also be provided on a remote handheld transceiver or other user interface device 121 such as, e.g., a HHRC in addition to the monitoring device 118, e.g., through a highly visible flashing light and a series of rapid audio beeps. The beeps may occur once, pause one second, then repeat, while the flashing light continues.

An emergency notification may not stop until the CG has manually preformed one of the following actions to deactivate the notification:
Placing the CRM system in standby (or alarm silence) by, e.g., pressing a key on the monitoring device 118 or a remote user interface device.
Shutting down the CRM system.

As discussed above, the sensors 115 (FIG. 1) are monitored by the monitoring device 118 (FIG. 1) and provides the CG with audible and/or visual notifications of the CR activity as well as providing notifications of CRM system status and offering various programming functions for setting the CRM system components relative to a specific installation. In some embodiments, the monitoring device 118 may be small enough to be portable and carried by the CG. The monitoring device 118 may function as a portable handheld transceiver that the CG may use to obtain knowledge of the CRM system status and to control various CRM system functions. In alternative embodiments, the monitoring device 118 may function as a base unit located at a specific place for controlling the CRM system or alternatively communication with a remote user interface device 121 (FIG. 1) that may be carried by the CG or other individual and that receives communications from the monitoring device 118 so that the CG is kept fully informed and is able to control the CRM system when not at the place of the base unit.

Referring to FIG. 10, shown is a block diagram 1000 of an example of a monitoring device 118 (FIG. 1) such as, e.g., a main control panel (MCP) in accordance with various embodiments of the present disclosure. The heart of the monitoring device 118 is a system micro-controller (or processor) 1003 that is coupled to, e.g., RF transceiver module 1006 that is in communication with one or more sensors 115 (FIG. 1). The RF transceiver 1006 may utilize a data protocol such as Zigbee or other appropriate data protocol for transmission of the door sensor status. Other inputs to the system micro-controller 1003 are interface inputs 1009 such as, e.g., push button or key inputs, a real time clock 1012 and a setup control 1015 such as, e.g., PRM dip switches. A display 1018 is also coupled to the system micro-controller 226. Outputs from the system micro controller 1003 include an audio interface 1021 such as, e.g., an audio controller coupled to audio amplifier that provides audio signals to a speaker 1024, a rest location (e.g., bed) status indicator 1027, a power indicator 1030, and a USB interface 1033 such as, e.g., a USB controller coupled to a USB connector. The monitoring device 118 is powered by a power source 1036, e.g., a 9 volt supply that feeds through a power regulator 1039 to power all circuits 1042. A back-up source 1045 such as, e.g., batteries is connected to the power regulator 1039 in the event the external power fails. The monitoring device 118 can be connected to a mains supply to recharge battery or power the system.

As illustrated in FIGS. 3, 5, and 8, there are setup controls associated with the sensors that are user accessible including the occupancy sensor 330 (FIG. 4), the motion sensor 530 (FIG. 6), and the door sensor 830 (FIG. 9). In addition the monitoring device 118 also includes a setup control 1015 (FIG. 10) such as, e.g., dip switches and/or an additional programming function that provides for the monitoring device's network ID to be changed. This provides a way for a user to manually change the unique network ID if there are multiple CRM systems being used in proximity of each other, in order to avoid any conflict. It is recommended that users verify that the network ID being used by the monitoring device 118 is different from any existing CRM system that is being used in close proximity, e.g., a nursing home next door or within 300 feet, or a neighbor with a similar CRM system. If two or more systems having the same network ID are within range of each other, they can interfere with each other and provide false indications of the CRM system status.

Each CRM system may be factory set to operate at one of 255 (or possibly 256) different network IDs in order to provide a reasonable probability that CRM systems operating in close proximity will not have the same network ID. The range, or distance between a sensor 115 (FIG. 1) and the monitoring device 118 (FIG. 1) may be up to 1000 feet in certain conditions, however typically in a home situation, a range of about 300 feet is normal. The DIP switches in a setup control 1015 may have 8 positions that can be set to either on or off. A table of the switch settings and the resulting network ID may be furnished with the CRM system to allow for user setup.

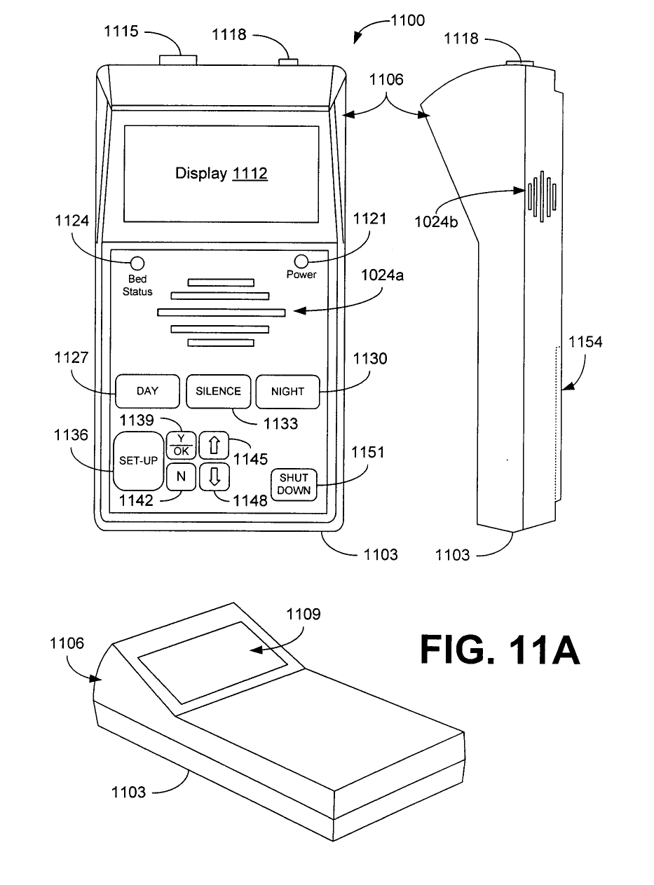

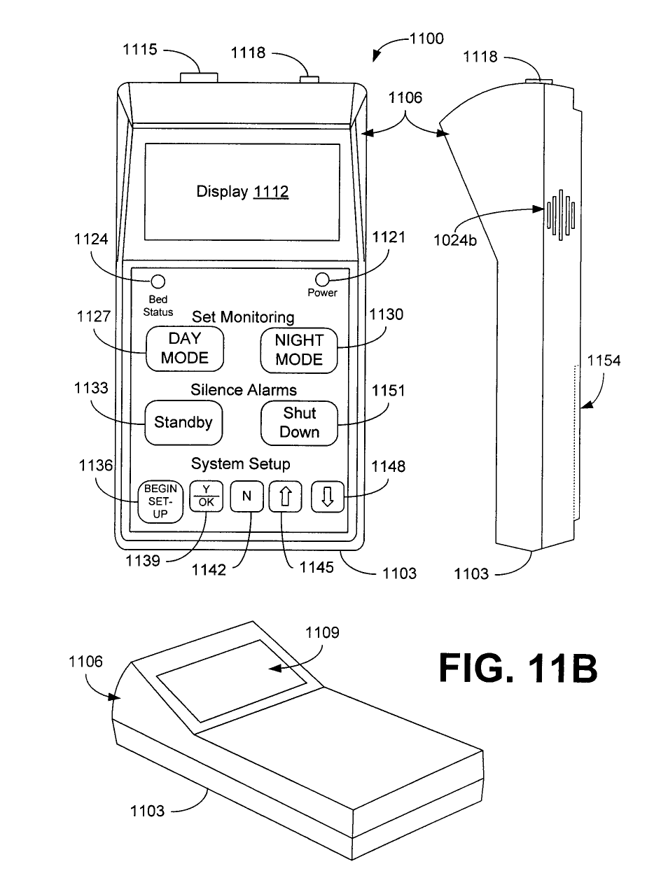

FIGS. 11A and 11B illustrate examples of a MCP 1100 that may be used as a portable monitoring device 118 for the CRM system. The MCP 1100 includes a case or housing 1103 in which the components of FIG. 10 are housed. The housing 1103 includes a forward section 1106 that is tilted upwardly and includes a cutout 1109 for a display 1112. The speaker 1024 (FIG. 10) may be located in the case either on the top face 1024a and/or on one side 1024b. A USB port 1115 for the USB interface 1033 (FIG. 10) and a DC jack 1118 for power input to power source 1036 (FIG. 10) may be located on the back edge of the housing 1103. Below the display 1112 are two LEDs 1121 and 1124 for power indicator 1027 (FIG. 10) and for rest location status indictor 1030 (FIG. 10), respectively.

Below the speaker 1024a in FIG. 11A are three buttons for DAY 1127, NIGHT 1130 and SILENCE (or standby) 1133. At the front of the housing 1103 is a push button arrangement or cluster consisting of a set-up button 1136, beside which is a YES/OK button 1139 and a NO button 1142. Next to them are a button with an up-arrow 1145 and a button with a down-arrow 1148. A shut down button 1151 is at the right front corner of the housing 1103. A battery compartment 1154 may be built into the housing as shown. FIG. 11B illustrates another embodiment of the MCP 1100 with a different push button arrangement or cluster at the front of the housing 1103.

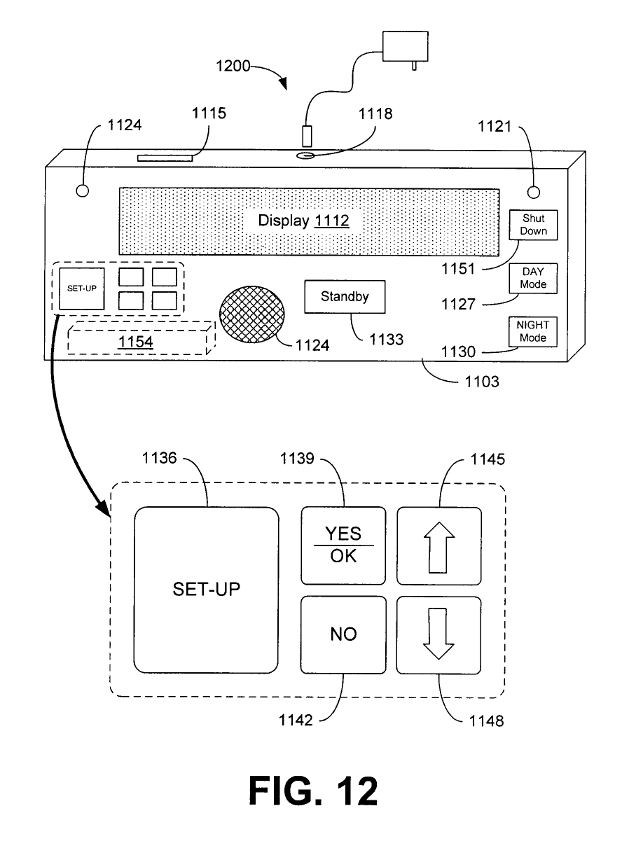

FIG. 12 illustrates an example of a MCP 1200 that may be used as a stationary monitoring device 118 for the CRM system. The MCP 1200 includes a case or housing 1103 in which the components of FIG. 10 are housed. The housing 1103 includes a display 1112 and a speaker 1024 (FIG. 10) in the front face of the housing 1103. A USB port 1115 for the USB interface 1033 (FIG. 10) and a DC jack 1118 for power input (e.g., a 9V plug in transformer) to power source 1036 (FIG. 10) may be located on the top and/or back edge of the housing 1103. On the sides of the display 1112 are two LEDs 1121 and 1124 for power indicator 1027 (FIG. 10) and for rest location status indictor 1030 (FIG. 10), respectively.

Below the display 1112 are three buttons for DAY 1127, NIGHT 1130 and SILENCE (or standby) 1133. At the front of the housing 1103 is a push button arrangement or cluster consisting of a set-up button 1136, beside which is a YES/OK button 1139 and a NO button 1142. Next to them are a button with an up-arrow 1145 and a button with a down-arrow 1148. A shut down button 1151 is to the right of the display 1112. A battery compartment 1154 may be built into the housing as shown.

The CRM system may be deactivated using the shut down button 1151. In some implementations, the shut down button 1151 is pressed twice to deactivate the CRM system. For example, pressing the shut down button 1151 once causes the monitoring device 118 to present a text message such as, e.g., “To turn off press SHUT DOWN Again” on display 1112 and to beep once, which may be followed by a voice message announcing “Press SHUT DOWN again to disable system.” If not pressed within a predefined time period, e.g., 5 seconds, the CRM system reverts to the previous operational mode. If pressed within the time period, all status indicators are turned off and the time of shutdown is displayed. An announcement that the system is idle may also be provided.

The monitoring device power indicator 1027 (FIG. 10) includes, e.g., a green LED 1121 that indicates that an external power supply (e.g., a 9V power supply) is connected to the monitoring device 118. If the monitoring device 118 is operating from a battery backup source, the LED 1121 may blink and the display backlighting may automatically revert to a lower power setting to conserve battery power.

The standby/silence button 1133 on the monitoring device 118 may be used to temporarily silence a notification such as an alarm condition. The alarm condition may be put on hold or suspended for the duration of the standby time, and resumes from where it was or its previous condition when the standby time expires. Pressing the standby/silence button 1133 once may initiate a 10 second timeout period that starts counting down. Pressing the standby/silence button 1133 again, may add 50 seconds to the time, and successive presses of standby/silence button 1133 may add increments of 60 seconds to the countdown timeout. For example, pressing the standby/silence button 1133 causes the monitoring device 118 to present a text message such as, e.g., “STANDBY Monitoring Off: MM:SS Timer” on display 1112 where MM:SS indicates the standby time (minutes:seconds). The monitoring device 118 may also beep, which may be followed by a voice message announcing “system in standby mode.” The standby time counts down in the display during standby. The monitoring device 118 may also provide messages while in standby that include the sensor name, the type of notification, and the time remaining for the standby period. For example, “STAND BY: 60 sec FDOOR EMERGENCY” may be used to indicate that 60 seconds remain for the emergency notification from the front door.

A standby period may be exited prior to timeout by, e.g.:
Pressing Daytime or Night time mode buttons 1127 or 1130. If all sensors 115 are in the normal mode, the operational mode will reset as selected.
Pressing Shutdown will deactivate the CRM system.
If a BO sensor 115a (FIG. 1) indicates that the CR has returned to bed during the standby timeout, and the CRM system was in the night mode, then the CRM system resumes normal night mode operation.
   If the standby period passes, the CRM system reverts to the original notification condition.

Pressing the day time mode button 1127 can initiate a day time operational mode and enables a predefined group of sensors 115 (e.g., E-sensors) while the other sensors remain disabled. The monitoring device 118 can display a message indicating that the system is in the day time mode. The predefined group of sensors may need to be in the set state for activation of the operational mode.

Pressing the night time mode button 1130 can initiate a night time operational mode and enables the BO sensor 115a (FIG. 1) while the other sensors remain disabled. The monitoring device 118 can display a message indicating that the system is in the night time mode. The BO sensor 115a must be in the bed occupied (deactivated) state to enable night mode. If the BO sensor 115a indicates that the CR is not in bed 112a (FIG. 1), then the monitoring device 118 provides an audio alarm of, e.g., three beeps and a voice message such as, e.g., “bed is not occupied, cannot enable night mode.” If the bed is not occupied within a predefined time period (e.g., 5 minutes), the CRM system reverts back to the previous operational mode.

The CRM system may be configured to automatically start the night mode of operation at a preset time or to provide a notification prompting the CG to start the night mode of operation. An “auto-start” time may be entered by the CG or other user through a setup menu. When the time occurs, a notification is automatically provided. If the CR is in bed 112a, then the CG may initiate the night mode by pressing button 1130. In some implementations, the CRM system may automatically initiate the night mode if the BO sensor 115a indicates that the CR is in bed 112a.

The rest location status indicator (e.g., a bed status indicator) 1124 may be a LED that is on when the rest location (e.g., bed 112a) is occupied and off otherwise.

The push button cluster on the monitoring device 118 may be used to setup and control functions of the CRM system. For example, the buttons may be used in the setup of:
Bed occupancy time out period.
Setting night mode “Auto-start” time.
Sensor setup (e.g., select sensor classification and/or change factory designated functions).
Sensor testing.
Setting the time of day (real time clock).
Setting/adjusting notification levels (e.g., volume and display intensity settings).
Accessing recorded information that may be stored in a data log or other file in a data store.
Defining CR profile information such as, e.g., identified CR patterns of activity and associated notifications.

The USB port 1115 for the USB interface 1033 (FIG. 10) allows for access to the system controller and any applications and/or data that may be stored in a data store associated with the monitoring device 118. For example, notifications, responses, and other events that have been recorded in a data log may be accessed through the USB port 1115. In some cases, the USB port 1115 (or other network interface) may be used to allow for data communication with one or more computing devices by way of a network such as, e.g., the Internet, intranets, extranets, wide area networks (WANs), local area networks (LANs), wired networks, wireless networks, or other suitable networks, etc. For example, data stored by the monitoring device 118 may be accessed by a remote user interface device such as a computer, touchpad, smartphone, etc. through the network connection. The monitoring device 118 may also store information and data in remotely located data stores which may be in one or more server banks or computer banks or other arrangements such as a cloud computing resource, a grid computing resource, and/or any other distributed computing arrangement. The USB port 1115 may also be used to allow other user interface devices to setup the CRM system.

The display 1112 may be a LCD or other appropriate display which allows for two or more lines of characters or other forms of graphical representations. Backlighting may be provided with a user selectable high and low light setting. The display 1112 is used to let the GC know the CRM system status and to set up the CRM system.

Battery backup 1154 may be provided to ensure operation of the CRM system 118 during power transients and outages. Notifications may be provided to inform the CG or other user that the backup power is running out or that battery conditions have declined to the point where the batteries need to be replaced. Notifications may include an audio alarm of, e.g., one beep and a voice message announcing “power out, system running on batteries” or “system low battery detected, replace batteries.” In some cases, the remaining battery life may be indicated. The display 1112 may alternate between the previous notification message and the battery condition message in a sequence such as 1 sec the battery message and three seconds for the previous notification display. The displayed notification message will change as needed to display any conditions that exist (e.g., day or night mode can change to a warning display if that condition occurs).

The monitoring device 118 is also configured to communicate with each sensor 115 in the CRM system to verify the operational status on a regular basis as long as the monitoring device 118 is powered up, regardless of the operational mode. The status information includes the battery voltage and the ambient temperature of the sensor 115. If a sensor's battery voltage falls below a level that the remaining battery capacity will sustain the component for approximately 1 month, the CRM system will provide a notification including an audio alarm of one beep and a voice message similar to the battery backup discussed above. The monitoring device 118 may also provide a sensor temperature notification including an audio alarm of one beep and a voice message, if the ambient temperature of the sensor 115 falls below 40° F. or goes above 105° F. The notifications will also include the name or identifier of the sensor 115. As discussed, the display 1112 flashes between the previous notification message and the battery message.

The speaker 1124 allows for various types of audio notifications such as, e.g., beeps and voice messages. Speaker volume can be set by the user for either low or high setting. In addition, notifications such as emergency alarms can cause an increase in the audio volume automatically. Beeps can be from one beep to a series of beeps depending on the system status and may be set by a user. Voice messages give verbal announcements of the system status. Both beeps and voice messages may be defined with each system control and system status.

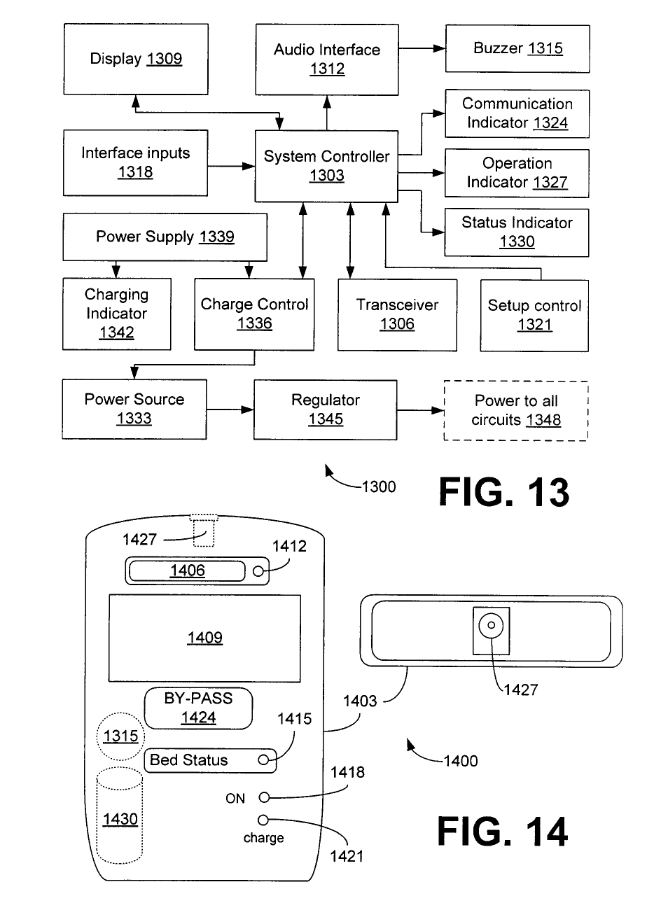

The monitoring device 118 may also provide remote notifications to a user interface device 121 (FIG. 1) such as, e.g., a hand held remote controller (HHRC). Referring now to FIG. 13, shown is a block diagram 1300 of an example of a HHRC in accordance with various embodiments of the present disclosure. The HHRC includes a system micro controller 1303 connected with RF transceiver module 1306 for communication with the monitoring device 118. The RF transceiver 1006 may utilize a data protocol such as Zigbee or other appropriate data protocol for transmission of the door sensor status. A display 1309 is also coupled to the system micro-controller 1303 to provide visual notifications. In addition, the system micro-controller 1303 is connected to an audible beeper/alarm status indicator including an audio interface 1312 (e.g., a piezo driver) coupled to a buzzer 1315 or a speaker. Other inputs to the system micro-controller 1003 are interface inputs 1318 such as, e.g., push button or key inputs and a setup control 1321 such as, e.g., PRM dip switches.

The display 1303 may include a series of colored (e.g., red, orange and yellow) LEDs or other graphical display as may be understood. For example, the display 1303 may be a LED panel having a strip of LED's with colors red (R), orange (O), and yellow (Y) arranged in a line such as ROYRORYRORYOR. The LED panel gives a visual alarm status indicator. It can flash yellow if indicating a notification, orange if indicating a warning and red if indicating an emergency. The flashing may coincide with the beeping of beeper 1315, and continues as long as the condition exists or standby/silence is activated. The buzzer 1315 may sound short “chirps” to indicate a notification, short beeps for indicating a warning, and long beeps for indicating an emergency. The beeping can continues as long as the condition exists or standby/silence is activated. The interface inputs 1318 include a bypass button that operates activate a standby/silence condition similar to standbay/silence button 1133 (FIGS. 11A, 11B, and 12) of the monitoring device 118.

The system micro controller 1303 may also be connected with a communication indicator 1324, an operation indicator 1327, and a status indicator 1330.

Power is supplied from a rechargeable power source 1333 such as, e.g., a rechargeable NiMH battery pack that is coupled to the system micro controller 1303 via a charge control circuit 1336 connected to a power supply 1339 through, e.g., a DC jack for battery supply charging. Also connected to the power supply 1339 is a charging indicator 1342. The output from the power source 1333 passes through a voltage regulator 1345 to apply power to all circuits 1348.

FIG. 14 illustrates an example of a HHRC 1400. The HHRC 1400 includes a case or housing 1403 in which the components of FIG. 13 are housed. The housing 1403 may be ergonomically shaped to fit into the hand. The housing 1403 includes a display 1406 on the top face of the housing. The display 1406 includes, e.g., an LED color panel. The HHRC 1400 may also include a display 1409 that displays notification information such as, e.g., type of notification (e.g., warning or emergency), time of notification or sensor indication, and/or sensor identification. Also on the top face of the case 1403 is a LED 1412 serving as a communication error for communication indicator 1324 (FIG. 13), a LED 1415 showing Bed status for the status indicator 1330 (FIG. 13), a LED 1418 showing power on or low power for the operation indicator 1327 (FIG. 13), a LED 1421 showing charging status for the charging indicator 1342 (FIG. 13) and a by-pass button 1424. The communication error LED 1412 will flash, if the HRC fails any communication with the monitoring device 118. The power status LED 1418 is on when Remote is on. If the HHRC batteries become low, this LED 1418 will be blinking (as well as sending this status to the monitoring device 118 where it would be also displayed). The occupancy status LED (BLUE) 1415 is on when the bed (or other rest location) is occupied.

The charging LED 1421 is on when the HHRC is being charged (e.g., a DC wall adapter plugged into DC jack 1427 to charge battery 1430. The HHRC uses batteries 1430 that include a rechargeable battery pack of, e.g., three NiMH, 700 mAh, batteries. The HHRC 1400 may operate a minimum of 100 hours on a full charge and may be rechargeable through terminal 1427 as noted above. A transformer can be plugged into a wall mains and supply DC power for charging the batteries.

The by-pass button 1424 may be lit when the CRM system is in a day time monitoring mode and the emergency sensors are active. Pressing the by-pass button 1424 once provides a special mode that disables the emergency sensors for 10 seconds allowing the CG to exit a monitored door. After 10 seconds the emergency sensors becomes active again. If an alarm condition exists (notification, warning or emergency), the by-pass button 1424 will operate in the same way as the monitoring device 118 standby/silence button 1133 when pressed (e.g., the audio alarm is silenced for 10 seconds first press, 60 seconds with 2 presses, 120 seconds with 3 presses, etc.). The HHRC 1400 LED panel will show the alarm condition, but the buzzer 1315 or speaker located inside the case 1403 will be silenced. The monitoring device 118 display and audio will function as if the standby/silence button 1133 on the monitoring device 118 was pressed.

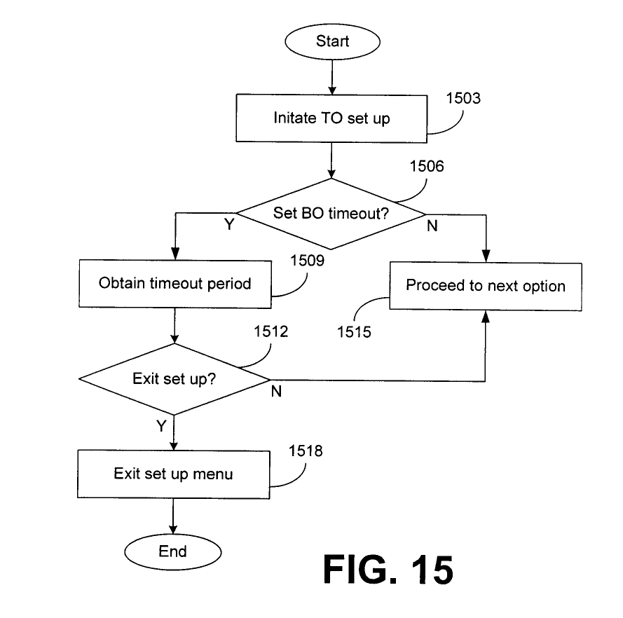

Referring next to FIGS. 15-22, shown are flow charts illustrating set up functions of the monitoring device 118 such as, e.g., a MCP 1100 of FIGS. 11A and 11B or a MCP 1200 of FIG. 12. While the set up functions are discussed with respect to the interfaces of the portable and base station MCPs 1100 and 1200, in some implementations computing devices may communicate with the MCP 1100/1200 to set up the CRM system functions. The computing device may connect to the MCP 1100/1200 through the USB port 1115 for the USB interface 1033 or through another network and/or networking connection as can be appreciated.

With respect to FIG. 15, shown is a flow chart illustrating setting up an occupancy time out period (e.g., a time out associated with a bed occupancy (BO) sensor 115a of FIG. 1). To begin setting up a BO time out period, press the set up button 1136 in block 1503. In block 1506, the display 1112 will show a prompt such as, e.g., “SET BO TIMEOUT? YES or NO.” If yes 1139 is selected, the flow increments and the display 1112 prompts with, e.g., “BO TIMEOUT - - - Seconds.” In block 1509, the timeout period is obtained. For example, the CRM system default may be set for 5 minutes (300 seconds), and the user can add or subtract time using the up arrow key 1145 and down arrow key 1148. The time out period may be entered in seconds and confirmed by pressing the yes/ok button 1139. In block 1512, the display 1112 will now read, e.g., “EXIT SET UP? YES or NO.” By pressing the no button 1142, the flow will proceed to the next set up option in block 1515. By pressing the yes button 1139, the flow will exit the set up menu in block 1518, and revert to idle status. If either the no button 1142 or the set up button 1136 is pressed in response to the prompt in block 1506, the flow will move to the next set up option in block 1615. If set up options are complete, then the flow will exit the set up menu.

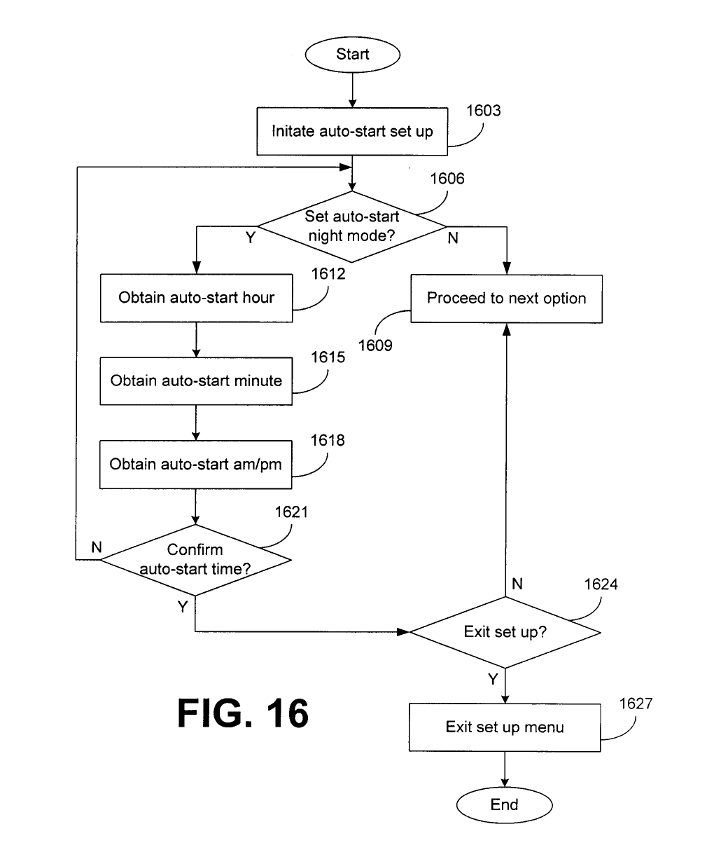

With respect to FIG. 16, shown is a flow chart illustrating setting up a night mode auto-start time. To begin setting up an auto-start time, press the set up button 1136 in block 1603. In block 1606, the display 1112 will show a prompt such as, e.g., “AUTO-START NIGHT MODE? YES or NO.” If either the no button 1142 or the set up button 1136, the flow will move to the next set up option in block 1609. If set up options are complete, then the flow will exit the set up menu. If yes 1139 is selected is pressed in response to the prompt in block 1606, the display 1112 will prompt the user to set the hour, e.g., “% OK WHEN DONE:MM A(P).” In block 1612, the up/down arrows 1145/1148 may be used to set the hour, which is confirmed by pressing the yes/ok button 1139 when done. When OK is pressed, the display 1112 shows, e.g., “↑↓OK WHEN DONE HH: A(P).” In block 1615, the up/down arrows 1145/1148 may be used to set the minute, which is confirmed by pressing the yes/ok button 1139 when done. The display 1112 then prompts with, e.g., “↑↓OK WHEN DONE HH:MM.” In block 1618, the up/down arrows 1145/1148 may be used to select either a.m. or p.m., which is confirmed by pressing the yes/ok button 1139 when done. The auto-start time is confirmed in block 1621 by displaying, e.g., “TIME OK? YES or NO HH:MM A(P)”. If no 1142 selected, the flow will loop back to block 1606 and the auto-time set up can be repeated. If yes 1139 is selected, the flow advances to block 1624 the display 1112 will now read, e.g., “EXIT SET UP? YES or NO.” By pressing the no button 1142, the flow will proceed to the next set up option in block 1609. By pressing the yes button 1139, the flow will exit the set up menu in block 1627, and revert to idle status. When the auto-start time occurs, the CRM system may provide notice to the GC to start the night mode. If the night mode is not manually started in 5 minutes, the system automatically goes into the day mode. In other implementations, the CRM system may automatically initiate the night mode if the appropriate conditions are met.

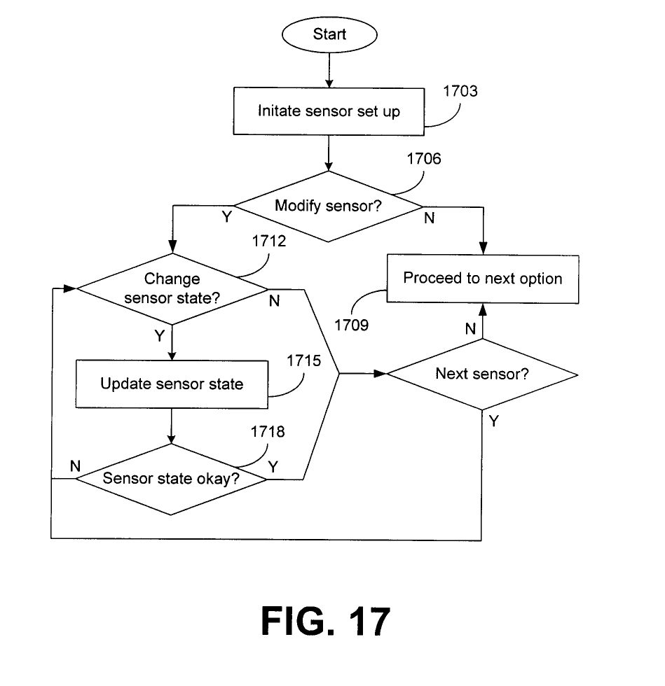

With respect to FIG. 17, shown is a flow chart illustrating setting up sensor functions. To begin setting up for sensor functions, press the set up button 1136 in block 1703. In block 1706, the display 1112 will show a prompt such as, e.g., “MODIFY SENSORS? YES or NO.” If either the no button 1142 or the set up button 1136, the flow will move to the next set up option in block 1709. If set up options are complete, then the flow will exit the set up menu. If yes 1139 is selected in response to the prompt in block 1706, the display 1112 will prompt the user to determine if the sensor state (or classification) such as emergency or notation should be changed by showing, e.g., “CHANGE [sensor name] FROM [current state] Y/N?” Pressing the yes button 1139 in block 1712 changes the sensor state (and function) in block 1715. The display 1112 prompts confirmation by showing, e.g., “[sensor name] SET AS [new state] OK?” in block 1718. If no 1142 is selected, the flow loops back to block 1712. If yes 1139 is selected in response to block 1718 or no 1142 is selected in response to block 1712, then the display 1112 will show a prompt such as, e.g., “NEXT SENSOR? YES or NO.” If either the no button 1142 or the set up button 1136, the flow will move to the next set up option in block 1709. If yes 1139 is selected, the flow loops back to block 1712 for the next sensor. Sensor set up may be used to modify the default setting of the sensors. Only the sensors that are “active” in the CRM system will show up in the menu, therefore all sensors used in the CRM system should be in place and powered up when assigning the sensor type.

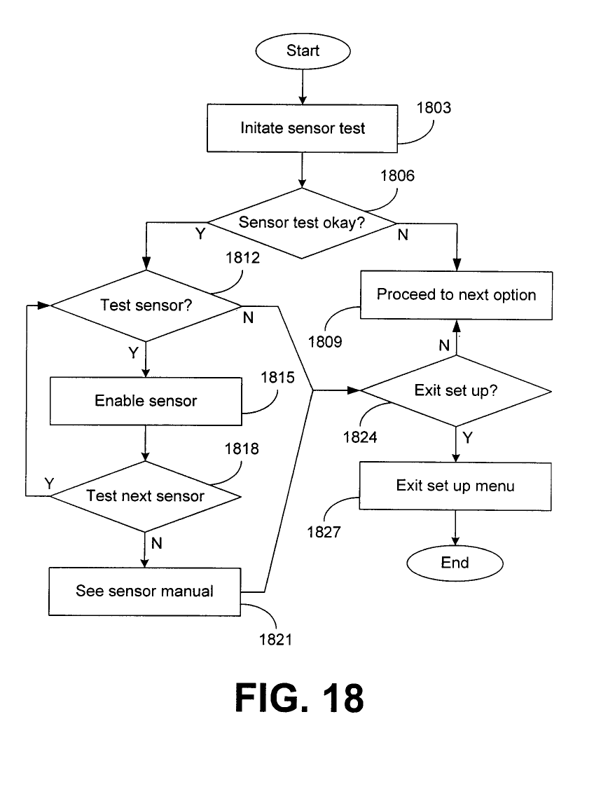

With respect to FIG. 18, shown is a flow chart illustrating sensor testing. To begin testing sensors, press the set up button 1136 in block 1803. In block 1806, the display 1112 will show a prompt such as, e.g., “TESTSENSORS? YES or NO.” If either the no button 1142 or the set up button 1136, the flow will move to the next set up option in block 1809. If set up options are complete, then the flow will exit the set up menu. If yes 1139 is selected in response to the prompt in block 1806, the display 1112 will prompt the user to determine if the sensor testing should begin, e.g., “TEST [sensor name] NOW [active or idle] TEST OK Y/N?” If the YES button 1139 is pressed, the named sensor is enabled in block 1815, and testing the sensor (by activating it) will show as active for one second before the sensor reverts to idle. If the sensor includes a light, it may also be used to test the sensor. The flow then advances to block 1818 and the display 1112 shows, e.g., “TEST NEXT SENSOR? YES or NO.” If the yes button 1139 is pressed, the flow loops back to block 1812 and the next sensor is tested or not. If the NO button 1142 is pressed in response to the query of block 1818, then the user is prompted by the display 1112 to see the manual for sensor trouble in block 1821. This text may be displayed for about 2 seconds and then the display 1112 will prompt with, e.g., “EXIT SET UP? YES or NO” in block 1824. If the no button 1142 was selected in response to the prompt in block 1812, the flow will also proceed to block 1824. By pressing the no button 1142 in block 1824, the flow will proceed to the next set up option in block 1809. By pressing the yes button 1139, the flow will exit the set up menu in block 1827, and revert to idle status.

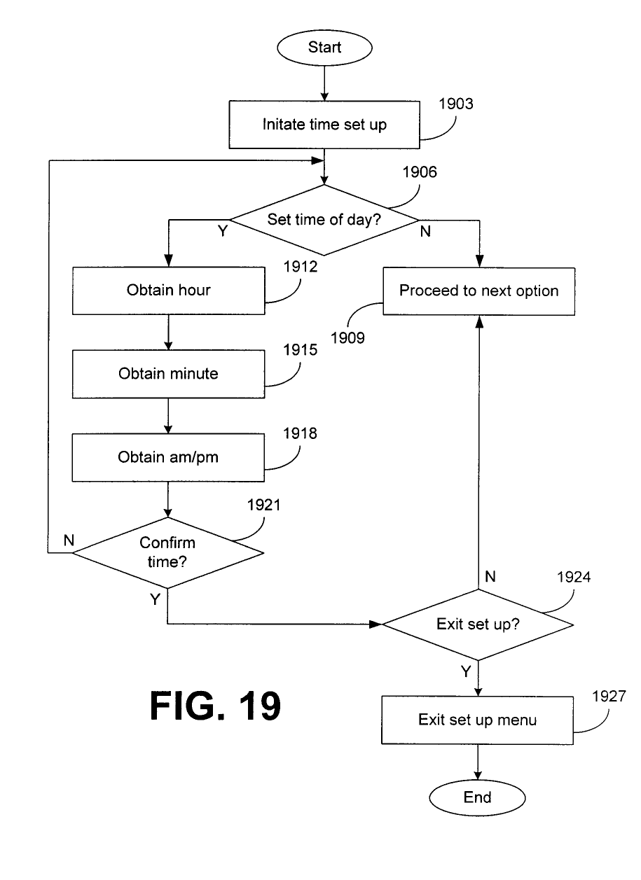

With respect to FIG. 19, shown is a flow chart illustrating setting up the time of day. To begin setting up the time, press the set up button 1136 in block 1903. In block 1906, the display 1112 will show a prompt such as, e.g., “SET TIME OF DAY? YES or NO.” If either the no button 1142 or the set up button 1136, the flow will move to the next set up option in block 1909. If set up options are complete, then the flow will exit the set up menu. If yes 1139 is selected in response to the prompt in block 1906, the display 1112 will prompt the user to set the hour, e.g., “↑↓OK WHEN DONE:MM A(P).” In block 1912, the up/down arrows 1145/1148 may be used to set the hour, which is confirmed by pressing the yes/ok button 1139 when done. When OK is pressed, the display 1112 shows, e.g., “↑↓OK WHEN DONE HH: A(P).” In block 1915, the up/down arrows 1145/1148 may be used to set the minute, which is confirmed by pressing the yes/ok button 1139 when done. The display 1112 then prompts with, e.g., “↑↓OK WHEN DONE HH:MM.” In block 1918, the up/down arrows 1145/1148 may be used to select either a.m. or p.m., which is confirmed by pressing the yes/ok button 1139 when done. The time is confirmed in block 1921 by displaying, e.g., “TIME OK? YES or NO HH:MM A(P)”. If no 1142 selected, the flow will loop back to block 1906 and the time set up can be repeated. If yes 1139 is selected, the flow advances to block 1924 the display 1112 will now read, e.g., “EXIT SET UP? YES or NO.” By pressing the no button 1142, the flow will proceed to the next set up option in block 1909. By pressing the yes button 1139, the flow will exit the set up menu in block 1927, and revert to idle status.

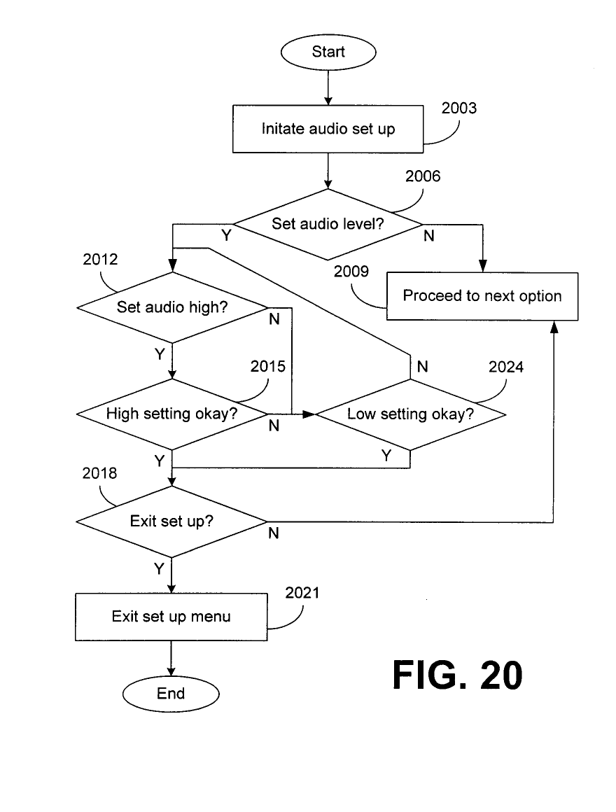

With respect to FIG. 20, shown is a flow chart illustrating setting up an audio notification level. To begin setting the audio level, press the set up button 1136 in block 2003. In block 2006, the display 1112 will show a prompt such as, e.g., “SET AUDIO? YES or NO.” If either the no button 1142 or the set up button 1136, the flow will move to the next set up option in block 2009. If set up options are complete, then the flow will exit the set up menu. If yes 1139 is selected in response to the prompt in block 2006, the display 1112 will prompt with, e.g., “SET AUDIO HIGH? YES or NO.” If yes 1139 is selected, in block 2012 the audio announces a voice message through the speaker at the high level such as, e.g., “High audio setting, is this okay?” This announcement may be repeated in one second intervals. If yes 1139 is selected in block 2015, the flow advances to block 2018 the display 1112 will now read, e.g., “EXIT SET UP? YES or NO.” By pressing the no button 1142, the flow will proceed to the next set up option in block 2009. By pressing the yes button 1139, the flow will exit the set up menu in block 2021 and revert to idle status. If the no button 1139 is pressed, the flow advances to the next menu item in block 2009. If the no button 1139 is pressed in either block 2012 or block 2015, the flow increments to block 2024 and the audio announces a voice message through the speaker at the low level such as, e.g., “Low audio setting, is this okay?” This announcement may be repeated in one second intervals until the yes button 1142 or the no button 1139 is selected. If yes 1142 is selected, the flow advances to block 2018. If the no button 1139 is pressed, the flow loops back to block 2012.

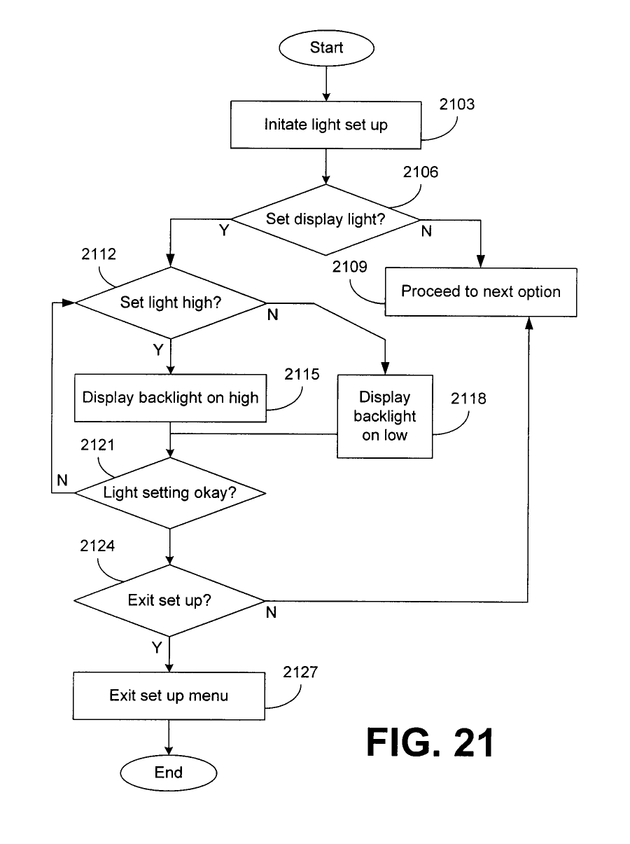

With respect to FIG. 21, shown is a flow chart illustrating setting up a display light level. To begin setting the light level, press the set up button 1136 in block 2103. In block 2106, the display 1112 will show a prompt such as, e.g., “SET DISPLAY LIGHT? YES or NO.” If either the no button 1142 or the set up button 1136, the flow will move to the next set up option in block 2109. If set up options are complete, then the flow will exit the set up menu. If yes 1139 is selected in response to the prompt in block 2106, the display 1112 will prompt with, e.g., “SET LIGHT HIGH? YES or NO.” If yes 1139 is selected in block 2112, then the display backlight is displayed at the high level in block 2115, or if no 1142 is pressed, then the display backlight is displayed at the low level in block 2118. In either case, the display 1112 prompts for user confirmation by showing, e.g., “LIGHT OK? YES or NO.” If yes 1139 is selected in block 2121, the flow advances to block 2124 and the display 1112 will now read, e.g., “EXIT SET UP? YES or NO.” By pressing the no button 1142, the flow will proceed to the next set up option in block 2109. By pressing the yes button 1139, the flow will exit the set up menu in block 2127 and revert to idle status. If the no button 1139 is pressed in block 2121, the flow returns to block 2112 to adjust the light setting.

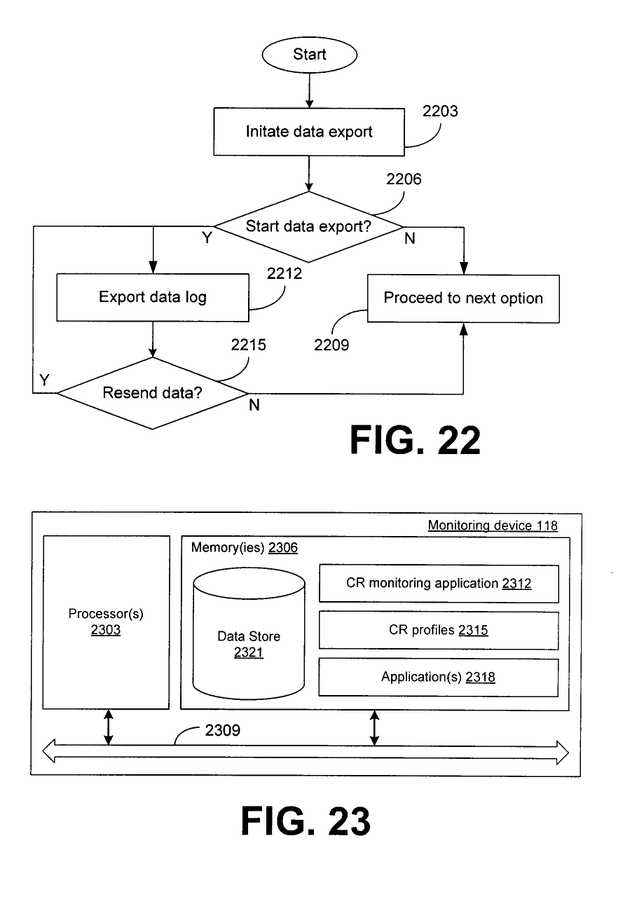

With respect to FIG. 22, shown is a flow chart illustrating the exporting of data from the CRM system. To begin a data export, press the set up button 1136 in block 2203. In block 2206, the display 1112 will show a prompt such as, e.g., “EXPORT DATA? YES or NO.” If either the no button 1142 or the set up button 1136, the flow will move to the next set up option in block 2209. If set up options are complete, then the flow will exit the set up menu. If the yes button 1139 is pressed, the flow advances to block 2212 and the display 1112 shows, e.g., “EXPORTING DATA LOG.” When complete, the display will show a prompt such as, e.g., “RESEND DATA? YES or NO.” If yes 1139 is selected, the flow returns to block 2212. If no 1142 is selected, the flow proceeds to block 2209.

With reference to FIG. 23, shown is a schematic block diagram of the monitoring device 118 (FIGS. 1, 11A, 11B, and 12) in accordance with various embodiments of the present disclosure. The monitoring device 118 includes a micro-controller circuit including at least one processor circuit, for example, having a processor 2303 and a memory 2306, both of which are coupled to a local interface 2309. To this end, the monitoring device 118 may comprise, for example, at least one computer or like device. The local interface 2309 may comprise, for example, a data bus with an accompanying address/control bus or other bus structure as can be appreciated.

Stored in the memory 2306 are both data and several components that are executable by the processor 2303. In particular, stored in the memory 2306 and executable by the processor 2303 are a CR monitoring application 2312, the CR profiles 2315, and potentially other applications 2318. Also stored in the memory 2306 may be a data store 2321 and other data. In addition, an operating system may be stored in the memory 2306 and executable by the processor 2303.

It is understood that there may be other applications that are stored in the memory 2306 and are executable by the processor 2303 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Delphi®, Flash®, or other programming languages.

A number of software components are stored in the memory 2306 and are executable by the processor 2303. In this respect, the term “executable” means a program file that is in a form that can ultimately be run by the processor 2303. Examples of executable programs may be, for example, a compiled program that can be translated into machine code in a format that can be loaded into a random access portion of the memory 2306 and run by the processor 2303, source code that may be expressed in proper format such as object code that is capable of being loaded into a random access portion of the memory 2306 and executed by the processor 2303, or source code that may be interpreted by another executable program to generate instructions in a random access portion of the memory 2306 to be executed by the processor 2303, etc. An executable program may be stored in any portion or component of the memory 2306 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 2306 is defined herein as including both volatile and nonvolatile memory and data storage components. Volatile components are those that do not retain data values upon loss of power. Nonvolatile components are those that retain data upon a loss of power. Thus, the memory 2306 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 2303 may represent multiple processors 2303 and the memory 2306 may represent multiple memories 2306 that operate in parallel processing circuits, respectively. In such a case, the local interface 2309 may be an appropriate network that facilitates communication between any two of the multiple processors 2303, between any processor 2303 and any of the memories 2306, or between any two of the memories 2306, etc. The local interface 2309 may comprise additional systems designed to coordinate this communication, including, for example, performing load balancing. The processor 2303 may be of electrical or of some other available construction.

Although the CR monitoring application 2312, the CR profiles 2315, applications 2318, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flow charts of FIGS. 2 and 15-22 show the functionality and operation of an implementation of portions of the CR monitoring application 2312 and the CR profiles 2315. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 1003 in a computer system or other system. The machine code may be converted from the source code, etc. If embodied in hardware, each block may represent a circuit or a number of interconnected circuits to implement the specified logical function(s).

Although the flow charts of FIGS. 2 and 15-22 show a specific order of execution, it is understood that the order of execution may differ from that which is depicted. For example, the order of execution of two or more blocks may be scrambled relative to the order shown. Also, two or more blocks shown in succession in FIGS. 2 and 15-22 may be executed concurrently or with partial concurrence. Further, in some embodiments, one or more of the blocks shown in FIGS. 2 and 15-22 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the CR monitoring application 2312, the CR profiles 2315, and the applications 2318, that comprises software or code can be embodied in any non-transitory computer-readable medium for use by or in connection with an instruction execution system such as, for example, a processor 2303 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a range of “about 0.1% to about 5%” should be interpreted to include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A method for monitoring care receiver activity, comprising:
obtaining an indication from an occupancy sensor that a care receiver has left a rest location;
in response to the occupancy sensor indication, enabling at least one sensor along a perimeter of a predefined zone of activity including the rest location; and
providing a notification in response to activation of the at least one sensor by activity of the care receiver.

2. The method of claim 1, wherein a plurality of sensors are enabled in response to the occupancy sensor indication.

3. The method of claim 2, wherein the plurality of sensors includes a second sensor associated with a second predefined zone of activity.

4. The method of claim 1, wherein the notification is an audible alarm provided by a monitoring device at a first alarm level.

5. The method of claim 4, wherein the audible alarm is increased to a second alarm level if a response to the notification is not received within a predefined period.

6. The method of claim 1, further comprising:
obtaining a series of indications of care receiver activity from a plurality of sensors; and
identifying a repeated pattern of care receiver activity based at least in part upon the series of indications.

7. The method of claim 6, further comprising providing a notification of the repeated pattern of care receiver activity.

8. The method of claim 6, further comprising modifying the notification in response to the activation of the at least one sensor based upon the identified pattern of care receiver activity.

9. The method of claim 8, wherein modifying the notification comprises providing an audible alarm in addition to a notification message.

10. The method of claim 6, wherein the repeated pattern of care receiver activity includes an elapsed time between at least two indications of the series of indications.

11. The method of claim 1, further comprising:
obtaining an indication of a caregiver response to the notification; and
storing information corresponding to the notification and the indication of caregiver response in a data store.

12. The method of claim 11, wherein the data store is remotely located on a network server.

13. The method of claim 11, further comprising providing a second notification if the indication of caregiver response is not received within a predefined time period after providing the first notification.

14. The method of claim 1, further comprising enabling a second sensor along a perimeter of a second predefined zone of activity in response to activation of the at least one sensor, wherein the second predefined zone of activity includes the first predefined zone of activity.

15. A care receiver monitoring system, comprising:
an occupancy sensor configured to provide an indication that a care receiver has left a rest location;
at least one sensor configured to monitor care receiver activity with respect to a zone of activity including the rest location; and
a monitoring device in communication with the occupancy sensor and the at least one sensor, the monitoring device configured to:
enable the at least one sensor in response to an occupancy sensor indication that the care receiver has left the rest location; and
provide a notification in response to activation of the at least one sensor by activity of the care receiver.

16. The care receiver monitoring system of claim 15, wherein the monitoring device is further configured to learn patterns of activity of the care receiver based at least in part upon the indications received from a plurality of sensors in communication with the monitoring device.

17. The care receiver monitoring system of claim 15, wherein the notification is based at least in part upon a current operational mode of the monitoring system.

18. The care receiver monitoring system of claim 15, wherein the monitoring device is further configured to provide a notification in response to activation of the occupancy sensor.

19. The care receiver monitoring system of claim 15, wherein the monitoring device is further configured to provide the notification to a remotely located user interface device.

20. The care receiver monitoring system of claim 19, wherein the monitoring device is further configured to provide a second notification to the remotely located user interface device if an indication of caregiver response is not obtained within a predefined time after providing the first notification.

21. The care receiver monitoring system of claim 15, wherein the monitoring device is further configured to:
obtain an indication of caregiver response to the notification; and
deactivate the notification in response to the indication of caregiver response.

22. The care receiver monitoring system of claim 21, wherein the caregiver response is pressing a silence button on the monitoring device.

23. The care receiver monitoring system of claim 15, wherein the monitoring device is further configured to:
obtain indications of care receiver activity from a plurality of sensors associated with a protected premise including the zone of activity; and
store the obtained indications in a data store associated with the monitoring device.

24. The care receiver monitoring system of claim 23, wherein the data store is located remotely from the monitoring device.
